(19) United States
(12) Patent Application Publication
(10) Pub. No.: US 2016/0147167 A1
(43) Pub. Date: May 26, 2016

(54) TONER AND TONER PRODUCING METHOD, AND DEVELOPER

(71) Applicant: RICOH COMPANY, LTD., Tokyo (JP)

(72) Inventors: Tatsuru MORITANI, Shizuoka (JP); Yoshihiro MORIYA, Shizuoka (JP); Ryota INOUE, Shizuoka (JP); Tatsuki YAMAGUCHI, Shizuoka (JP)

(73) Assignee: Ricoh Company, Ltd., Tokyo (JP)

(21) Appl. No.: 14/899,425

(22) PCT Filed: Jun. 5, 2014
(86) PCT No.: PCT/JP2014/065520

§ 371 Date: Dec. 17, 2015

(30) Foreign Application Priority Data
Jun. 19, 2013 (JP) 2013-128095
Mar. 4, 2014 (JP) 2014-041248

(51) Int. Cl. G03G 9/087; G03G 9/08

(52) U.S. Cl. CPC G03G 9/08797; G03G 9/08795; G03G 9/0825; G03G 9/0819; G03G 9/0802

(57) ABSTRACT

Provided is a toner obtained by granulating a toner composition in a hydrophobic medium and then drying the granulated product. The toner contains a binder resin. The binder resin includes 2 or more kinds of binder resins having different contact angles (to water). The binder resin having the largest contact angle has a weight average molecular weight of 15,000 or less. The other binder resins have a weight average molecular weight of greater than 15,000.

### TECHNICAL FIELD

The present invention relates to a toner used for developing an electrostatic charge image in electrophotography, electrostatic recording, electrostatic printing, etc., and a toner producing method, and a developer.

### BACKGROUND ART

Conventionally, a pulverization method has been the only method for producing electrostatic charge image developing toners used in electrophotographic-recording-type copiers, printers, and facsimile machines, and multifunction peripherals in which these functions are combined. However, recently, a so-called polymerization method of producing toner particles in an aqueous medium has become common, and is even going to become the mainstream to replace the pulverization method. Toners produced by the polymerization method are called “polymerized toner”, or in some countries, “chemical toner”.

The polymerization method is called so because it involves a polymerization reaction of toner raw materials during the production of toner particles or during a process thereof. Various polymerization methods have been put into practice, including a suspension polymerization method, an emulsion aggregation method, a polymer suspension method (a polymer aggregation method), an ester elongation reaction method, etc.

A so-called polymer dissolution suspension method involving volume contraction is also under development (see PTL 1). This dissolution suspension method disperses or dissolves toner materials in a volatile solvent such as a low boiling point organic solvent, emulsifies them in an aqueous medium containing a dispersant to obtain liquid droplets of the materials, and after this, removes the volatile solvent. Unlike a suspension polymerization method and an emulsion polymerization aggregation method, the dissolution suspension method can use a wide variety of resins, and is particularly excellent in that it can use a polyester resin useful for a full-color process in which transparency and fixed image smoothness are required.

Generally, toners obtained by the polymerization method tend to have a smaller particle diameter and a narrower particle size distribution, and be closer to a sphere in shape, than toners obtained by the pulverization method. Therefore, it is advantageous to use a toner obtained by the polymerization method, in that high-quality images can be obtained in electrophotography. However, the polymerization method has to spend a long time on the polymerization process, and after caking the solvent and toner particles and separating them from each other, has to wash and dry the toner particles repeatedly. Therefore, the polymerization method is disadvantageous in that it requires a lot of time, water, and energy.

Hence, there are proposed jet granulating methods of prilling a liquid of toner raw material components dissolved in a solvent (hereinafter, may be referred to as toner composition liquid) with various types of atomizers, and after this, drying the prilled product to thereby obtain a powder toner (see, e.g., PTLs 2 to 4). These proposals can avoid the disadvantages of the polymerization method, because they need not use water and can downsize the washing and drying steps significantly.

However, according to the toner producing methods presented by these proposals, the toner to be obtained may be a result of a process that the liquid droplets formed by spraying the toner composition liquid merge with each other before dried, and the solvent dries from the merged state. Consequently, there is a problem that the particle size distribution of the obtained toner cannot avoid being broad, and cannot be adequate.

In regard to such a problem, there is proposed a toner producing method of applying a vibration having a constant frequency to a metal plate and thereby discharging liquid droplets from discharge holes formed in the metal plate (see PTL 5). The proposed technique can do without a lot of washing liquid and repetitive separation of the solvent and particles, and can produce a toner having a favorable particle size distribution at a very high productivity with saved energy.

Recently, from the viewpoint of saving energy, low-temperature fixable toners have been requested. Generally, toners that are requested are broad fixable range toners, with which troubles would not occur in the images from lower temperatures to higher temperatures. To secure low temperature fixability, toners are requested to be a lower molecular weight composition that melts at a lower temperature, whereas to secure fixability at a higher temperature, toners are requested to be a higher molecular weight composition that can maintain a higher melt viscosity up to a higher temperature (PTL 6). As a result, the molecular weight of the binder resin becomes high.

However, when a toner that can satisfy the fixability and heat resistant storage stability is produced by the toner producing method proposed in PTL 6, the molecular weight of the binder resin becomes high, to thereby degrade the drying property, which leads to a problem that toner droplets merge and bind with each other in a drying air stream to degrade the particle size distribution. Hence, there has been a problem in ensuring a toner both of a fixing range and a narrow particle size distribution.

### CITATION LIST

### Patent Literature

PTL 1 Japanese Patent Application Laid-Open (JP-A) No. 07-152202

PTL 2 Japanese Patent (JP-B) No. 3786034

PTL 3 JP-B No. 3786035

PTL 4 JP-A No. 57-201248

PTL 5 JP-A No. 2006-293320

PTL 6 JP-A No. 2002-14489

### SUMMARY OF INVENTION

### Technical Problem

The present invention was made in view of the problems described above, and an object of the present invention is to provide a toner that is obtained by granulating a toner composition in a hydrophobic medium and then drying the granulated product, and that can satisfy a narrow particle size distribution and fixability at the same time.

### Solution to Problem

The present invention as a solution to the problems described above has the characteristics described below in (1).

(1) A toner, including:

a binder resin,

wherein the toner is obtained by granulating a toner composition in a hydrophobic medium, and then drying a granulated product,

wherein the binder resin includes 2 or more kinds of binder resins having different contact angles (to water),

wherein the binder resin having a largest contact angle has a weight average molecular weight of 15,000 or less, and

wherein the other binder resins have a weight average molecular weight of greater than 15,000.

### Advantageous Effects of Invention

The present invention can provide a toner that can satisfy a narrow particle size diameter and fixability at the same time.

### BRIEF DESCRIPTION OF DRAWINGS

FIG. 1 is a cross-sectional diagram showing an example of a configuration of a liquid column resonance liquid droplet forming unit.

FIG. 2 is a cross-sectional diagram showing an example of a configuration of a liquid column resonance liquid droplet unit.

FIG. 3A is a schematic cross-sectional diagram showing an example of a discharge hole having a round shape.

FIG. 3B is a schematic cross-sectional diagram showing an example of a discharge hole having a taper shape.

FIG. 3C is a schematic cross-sectional diagram showing an example of a discharge hole having a straight shape.

FIG. 3D is a schematic cross-sectional diagram showing an example of a discharge hole having a round-taper combined shape.

FIG. 4A is a schematic explanatory diagram showing a standing wave of velocity and pressure pulsation when a liquid column resonance liquid chamber is fixed at one end and N=1, where P represents a pressure distribution, V represents a velocity distribution, and L=λ/4.

FIG. 4B is a schematic explanatory diagram showing a standing wave of velocity and pressure pulsation when a liquid column resonance liquid chamber is fixed at both ends and N=2, where L=λ/2.

FIG. 4C is a schematic explanatory diagram showing a standing wave of velocity and pressure pulsation when a liquid column resonance liquid chamber is free at both ends and N=2, where L=λ/2.

FIG. 4D is a schematic explanatory diagram showing a standing wave of velocity and pressure pulsation when a liquid column resonance liquid chamber is fixed at one end and N=3, where L=3λ/4.

FIG. 5A is a schematic explanatory diagram showing a standing wave of velocity and pressure pulsation when a liquid column resonance liquid chamber is fixed at both ends and N=4, where P represents a pressure distribution, V represents a velocity distribution, and L=λ.

FIG. 5B is a schematic explanatory diagram showing a standing wave of velocity and pressure pulsation when a liquid column resonance liquid chamber is free at both ends and N=4, where L=λ.

FIG. 5C is a schematic explanatory diagram showing a standing wave of velocity and pressure pulsation when a liquid column resonance liquid chamber is fixed at one end and N=5, where L=5λ/4.

FIG. 6A is a schematic explanatory diagram showing a liquid column resonance phenomenon arising in a liquid column resonance flow path of a liquid droplet forming unit, where V represents a velocity distribution and P represents a pressure distribution.

FIG. 6B is a schematic explanatory diagram showing a liquid column resonance phenomenon arising in a liquid column resonance flow path of a liquid droplet forming unit, where V represents a velocity distribution and P represents a pressure distribution.

FIG. 6C is a schematic explanatory diagram showing a liquid column resonance phenomenon arising in a liquid column resonance flow path of a liquid droplet forming unit, where V represents a velocity distribution and P represents a pressure distribution.

FIG. 6D is a schematic explanatory diagram showing a liquid column resonance phenomenon arising in a liquid column resonance flow path of a liquid droplet forming unit, where V represents a velocity distribution and P represents a pressure distribution.

FIG. 6E is a schematic explanatory diagram showing a liquid column resonance phenomenon arising in a liquid column resonance flow path of a liquid droplet forming unit, where V represents a velocity distribution and P represents a pressure distribution.

FIG. 7 is a schematic diagram of an example of a toner producing apparatus.

FIG. 8 is a cross-sectional diagram showing an example of a configuration of a liquid column resonance liquid droplet forming unit.

FIG. 9 is a schematic diagram of an example of a tandem full-color image forming apparatus.

FIG. 10A is a diagram for explaining a merged state of toner particles (part 1), showing a fundamental particle (4.2 μm).

FIG. 10B is a diagram for explaining a merged state of toner particles (part 2), showing a merged particle (5.3 μm) (2 particles).

FIG. 10C is a diagram for explaining a merged state of toner particles (part 3), showing a merged particle (6.1 μm) (3 particles).

FIG. 10D is a diagram for explaining a merged state of toner particles (part 4), showing a merged particle (6.7 μm) (4 particles).

FIG. 10E is a diagram for explaining a bound state of toner particles (part 1), showing a fundamental particle.

FIG. 10F is a diagram for explaining a bound state of toner particles (part 2), showing a bound particle (2 particles).

FIG. 10G is a diagram for explaining a bound state of toner particles (part 3), showing a bound particle (3 particles).

### DESCRIPTION OF EMBODIMENTS

An embodiment for carrying out the present invention will be explained below with reference to the drawings. So-called persons ordinarily skilled in the art could easily carry out other embodiments by making modifications and alternations to the present invention set forth in the scope of claims. Such modifications and alternations are included in the scope of claims, and the explanation given below presents the best mode of the present invention and is not to limit the scope of claims.

Toner materials and a toner will be explained first.

For example, the toner of the present invention contains at least a binder resin, a colorant, and a releasing agent, and contains a charge controlling agent, an additive, and other components according to necessity.

The toner of the present invention is obtained by granulating a toner composition in a hydrophobic medium and then drying the granulated product. The toner contains a binder resin. The binder resin contains 2 or more kinds of binder resins having different contact angles (to water). The binder resin having the largest contact angle has a weight average molecular weight of 15,000 or less. The other binder resins have a weight average molecular weight of greater than 15,000.

The hydrophobic medium is an apolar medium. Specific examples thereof include nitrogen, carbon dioxide, and argon.

The toner of the present invention preferably has a contact angle before hot-melted (CAa [°]) and a contact angle after hot-melted (CAb [°]) that satisfy the following (Formula I).

CAb+3°≦CAa (Formula I)

The angle CAa is preferably 65° or greater.

The value of CAa slightly varies depending on the binder resins. A binder resin of the toner is preferably a polyester resin in terms of low temperature fixability. When a polyester resin is used, CAa becomes 65° or greater.

When particles are dried in a hydrophobic medium, a hydrophobic material will be distributed unevenly in the surface of particles due to the balance of surface energy. The formula CAb+3°≦CAa means that materials are distributed unevenly in the toner particles before hot-melted. When this relationship is satisfied, it can be confirmed indirectly that a highly hydrophobic material, i.e., in the present embodiment, a binder resin having a large contact angle and a low molecular weight, is distributed unevenly in the surface of particles.

A “toner composition liquid” used in the present invention will be explained. The toner composition liquid may have a liquid state obtained by dissolving or dispersing the above toner components in a solvent, or the toner composition liquid needs not contain a solvent as long as it has a liquid state under discharging conditions. The toner composition liquid shows a liquid state that results from some or all of the toner components being mixed in their melted state.

It is possible to use as the toner materials, completely the same materials as those used for the conventional electrophotographic toners, as long as it is possible to prepare the above toner composition liquid. It is possible to prill these materials into minute liquid droplets with a liquid droplet discharging unit as described above, and to produce the intended toner particles with a liquid droplet solidifying/collecting unit.

### (Organic Solvent)

An organic solvent is not particularly limited and may be appropriately selected according to the purpose, as long as it can stably disperse a dispersion element such as a colorant. When collecting the toner with a cyclone, it is necessary to collect the toner by drying the toner composition liquid to a certain degree in a gas phase. Therefore, a solvent that can get easily dried is preferable. From the viewpoint of drying, the boiling point of the solvent is preferably 100° C. or lower.

Preferable examples of the organic solvent include ethers, ketones, esters, hydrocarbons, and alcohols. More preferable examples thereof include tetrahydrofuran (THF), acetone, methyl ethyl ketone (MEK), ethyl acetate, and toluene. One of these may be used alone, or two or more of these may be used in combination.

### (Binder Resins)

In the present invention, it is possible to satisfy both of a narrow particle size distribution and fixability at the same time, by using 2 or more kinds of binder resins having different molecular weights and different contact angles.

In the present invention, the contact angle of the binder resin materials is very important. When materials having different contact angles are granulated in a hydrophobic medium and dried, a material having lower energy, i.e., a material having a larger contact angle will be distributed unevenly in the surface of the particles, because a force of making the surface energy of the particles the smallest acts on the particles. On the other hand, in the chemical granulation, which is the recent years' mainstream toner producing method, there is a tendency that a material having higher energy, i.e., a material having a smaller contact angle is distributed unevenly in the surface of the materials, because the toner materials are dispersed in an aqueous phase in the form of an oil phase.

When a resin having a larger contact angle has a smaller molecular weight, by making this resin having a smaller molecular weight present in the surface of the toner particles to improve the drying speed in the drying of a toner, it is possible to prevent degradation of the particle size distribution.

In order to improve the drying property, it is necessary that the resin having a larger contact angle have a weight average molecular weight of 15,000 or less. This resin is not particularly limited in any other respects, and may be appropriately selected. The other binder resins have a weight average molecular weight of greater than 15,000.

The resins having a smaller contact angle and a larger weight average molecular weight are also not particularly limited. However, in terms of fixability, they may be preferably binder resins that have at least one peak in the molecular weight range of from 3,000 to 50,000, and that contain a THF soluble content, of which component having a molecular weight of 100,000 or less accounts for from 0.60 [%] to 100 [%] thereof. They may be more preferably binder resins that have at least one peak in the molecular weight range of from 5,000 to 20,000.

The present invention can achieve the intended effect by combining a resin having a weight average molecular weight of 15,000 or less and a resin having a weight average molecular weight of greater than 15,000. In this case, it is preferable that the resin having a weight average molecular weight of greater than 15,000 account for 50% by mass or greater of all of the resins, and it is more preferable that a resin having a weight average molecular weight of 20,000 or greater account for 50% by mass or greater of all of the resins. When 3 or more kinds of resins are used, it is preferable that a resin having a weight average molecular weight of greater than 15,000, or preferably a resin having a weight average molecular weight of 20,000 or greater account for 50% by mass or greater of all of the resins.

Examples of resins that can be used as the binder resins include: vinyl polymer of styrene-based monomer, acrylic-based monomer, methacrylic-based monomer, etc.; copolymer composed of these monomers or composed of 2 or more kinds of these monomers; polyester-based polymer; polyol resin; phenol resin; silicone resin; polyurethane resin; polyamide resin; furan resin; epoxy resin; xylene resin; terpene resin; coumarone-indene resin; polycarbonate resin; and petroleum-based resin.

Among these, polyester-based polymer is particularly preferable as the binder resins, in ters of low temperature fixability. As for a binder resin having a molecular weight of 15,000 or less, it is preferable to make the binder resin contain as a constituent component, a monomer having an aromatic ring in a large amount, because it is necessary to maintain the molecular weight of the binder resin low and make the binder resin express Tg of 50° C. or higher.

### —Method for Measuring Glass Transition Temperature (Tg)—

In the present invention, a glass transition temperature of a toner used as a target sample at the first temperature raising is referred to as Tg1st, and a glass transition temperature of the same at the second temperature raising is referred to as Tg2nd.

In the present invention, Tg of each constituent component at the second temperature raising is used as Tg of each target sample.

### —Method for Measuring Contact Angle—

Measurement of a contact angle is performed by measuring a static contact angle with an automatic contact angle meter (model No. CA-W) manufactured by Kyowa Interface Science Co., Ltd. It is possible to measure wettability of a liquid droplet attached on a surface of a solid, by selecting “drop method” in the software of the instrument. The specific measuring method is based on the sessile drop method according to JIS R3257.

### —Production of Sample Plate for Measurement of Contact Angle of Binder Resin—

A binder resin (3 g) is weighed out in an aluminum cup having a flat bottom, put in an oven heated to 120° C., and heated until the resin is melted sufficiently. After this, the resin is cooled until it is solidified, and taken out from the aluminum cup in the form of a resin plate, which is the sample plate for measurement of the contact angle. Here, the sample plate is examined to confirm that the bottom surface of the sample plate does not have any flaws such as undulations or cracks that would cause troubles in the measurement.

### —Production of Sample Plate for Measurement of Contact Angle of Toner—

A sample plate is produced by pressure-molding a toner with an automatic pressure molding machine. The molding conditions are as follows.

Amount of toner: 3 g

Load: 6 t

Time: 60 s

Diameter of molding die: 40 mm

—Production of Sample Plate for Measurement of Contact Angle of Toner after Hot-Melted—

A toner (3 g) is weighed out in an aluminum cup having a flat bottom, put in an oven heated to 120° C., and heated until the toner is melted sufficiently. After this, the toner is cooled until it is solidified, and taken out from the aluminum cup in the form of a toner plate, which is the sample plate for measurement of the contact angle. Here, the sample plate is examined to confirm that the bottom surface of the sample plate does not have any flaws such as undulations or cracks that would cause troubles in the measurement.

### (Colorant)

The colorant is not particularly limited and may be appropriately selected from colorants used in common. Examples thereof include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, lithopone, and a mixture of two or more of the preceding colorants.

The content of the colorant is preferably from 1% by mass to 15% by mass, and more preferably from 3% by mass to 10% by mass, relative to the toner.

The colorant used in the present invention may be used as a master batch in which it is combined with a resin. Examples of a binder resin to be kneaded with the master batch include: polymers of polyester resin and styrene or substituted products thereof (e.g., polystyrene, poly-p-chlorostyrene, and polyvinyl toluene); styrene copolymer (e.g., styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer); and others including polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, and paraffin wax. One of these may be used alone, or two or more of these may be used in mixture.

The master batch can be obtained by mixing and kneading the resin for master batch and the colorant with each other under a high shearing force. Here, in order to increase the interaction between the colorant and the resin, it is possible to use an organic solvent. It is also preferable to use a so-called flushing method of mixing and kneading a water-containing aqueous paste of the colorant with a resin and an organic solvent, transferring the colorant to the resin, and removing the water component and the organic solvent component, because with this method, a wet cake of the colorant can be used as is and needs not be dried. A high shearing disperser such as a three-roll mill is preferably used for the mixing and kneading.

The amount of use of the master batch is preferably from 2 parts by mass to 30 parts by mass, relative to 100 parts by mass of the binder resin.

It is preferable that the resin for master batch have an acid value of 30 mgKOH/g or less and an amine value of from 1 mgKOH/g to 100 mgKOH/g, in order to use the master batch in a colorant-dispersed state. It is more preferable that the resin for master batch have an acid value of 20 mgKOH/g or less and an amine value of from 10 mgKOH/g to 50 mgKOH/g, in order to use the master batch in a colorant-dispersed state. When the acid value is greater than 30 mgKOH/g, chargeability under high humidity conditions may be poor, and dispersibility of the pigment may be in sufficient. Also when the amine value is less than 1 mgKOH/g and greater than 100 mgKOH/g, dispersibility of the pigment may be insufficient. The acid value can be measured according a method described in JIS K0070, and the amine value can be measured according to a method described in JIS K7237.

In terms of dispersibility of the pigment, a dispersant preferably has a high compatibility with the binder resin. Specific examples of commercial products of the dispersant include “AJISPER PB821” and “AJISPER PB822” (manufactured by Ajinomoto Fine-Techno Co., Inc.), “DISPERBYK-2001” (manufactured by Byk-Chemie GmbH), and “EFKA-4010” (manufactured by EFKA Inc.)

### (Releasing Agent)

The toner composition liquid used in the present invention contains the binder resins, the colorant, and a releasing agent.

The releasing agent is not particularly limited, and a releasing agent appropriately selected from releasing agents used in common may be used. Examples of the releasing agent include: aliphatic hydrocarbon-based releasing agent such as low molecular weight polyethylene, low molecular weight polypropylene, polyolefin releasing agent, microcrystalline releasing agent, paraffin releasing agent, and Sasol releasing agent; oxide of aliphatic hydrocarbon-based releasing agent such as polyethylene oxide releasing agent or block copolymer thereof; plant-based releasing agent such as candelilla releasing agent, carnauba releasing agent, Japan tallow, and jojoba wax; animal-based releasing agent such as beeswax, lanolin, and cetaceum; mineral-based releasing agent such as ozokerite, ceresin, and petrolatum; releasing agent mainly composed of fatty acid ester such as montanic acid ester releasing agent and castor releasing agent; partially or completely deoxidized fatty acid ester such as deoxidized carnauba releasing agent.

The melting point of the releasing agent is preferably from 70 [° C.] to 140 [° C.], and more preferably from 70 [° C.] to 120 [° C.], in order to take a balance of fixability and offset resistance. When the melting point is lower than 70 [° C.], blocking resistance may be poor. When it is higher than 140 [° C.], it becomes harder to express the offset resistance effect.

The total content of the releasing agent is preferably from 0.2 parts by mass to 20 parts by mass, and more preferably from 0.5 parts by mass to 10 parts by mass.

In the present invention, the temperature of the peak top of the maximum peak among the endothermic peaks of the releasing agent measured by DSC (Differential Scanning calorimetry) is used as the melting point of the releasing agent.

A DSC measuring instrument for the releasing agent or the toner is preferably a highly-precise, inner-heat input-compensation differential scanning calorimeter. The measuring method is based on ASTM D3418-82. A DSC curve used in the present invention is a curve that is obtained when the temperature is raised at a rate of 10 [° C./min], after the temperature is once raised and lowered to get a previous history.

### (Charge Controlling Agent)

The charge controlling agent is not particularly limited, but is preferably a negatively-charging charge controlling agent that contains a polycondensate obtained from a polycondensation reaction of phenols and aldehydes, in terms of solubility in an organic solvent.

The phenols contain at least one kind of phenol compound that contains one phenolic hydroxyl group with which hydrogen is bonded at the ortho position thereof, and that is at least one phenol compound selected from the group consisting of p-alkylphenol, p-aralkylphenol, p-phenylphenol, and p-hydroxybenzoic acid ester.

As the aldehydes, aldehydes such as paraformaldehyde, formaldehyde, paraldehyde, and furfural may be appropriately used.

Examples of commercially-available products of the charge controlling agent include a charge controlling agent containing a FCA-N type condensed polymer (manufactured by Fujikura Kasei Co., Ltd.).

### (Particle Size Distribution of Toner)

A particle size distribution of the toner can be expressed as a ratio between a volume average particle diameter (Dv) and a number average particle diameter (Dn), and can be expressed as Dv/Dn. The value of Dv/Dn can be 1.00 at the minimum, and this means that all of the particles have the same diameter. A larger Dv/Dn means a broader particle size distribution. A common pulverized toner has a Dv/Dn of from about 1.15 to 1.25. A polymerized toner has a Dv/Dn of from about 1.10 to 1.15. The toner of the present invention has been confirmed to be effective for print quality when Dv/Dn thereof is 1.15 or less, and more preferably 1.10 or less.

In an electrophotography system, it is required in a developing step, a transfer step, and a fixing step that the particle size distribution be narrow. Therefore, a broad particle size distribution is undesirable. In order to obtain a highly precise image quality stably, Dv/Dn is preferably 1.15 or less. In order to obtain a more highly precise image, Dv/Dn should be 1.10 or less.

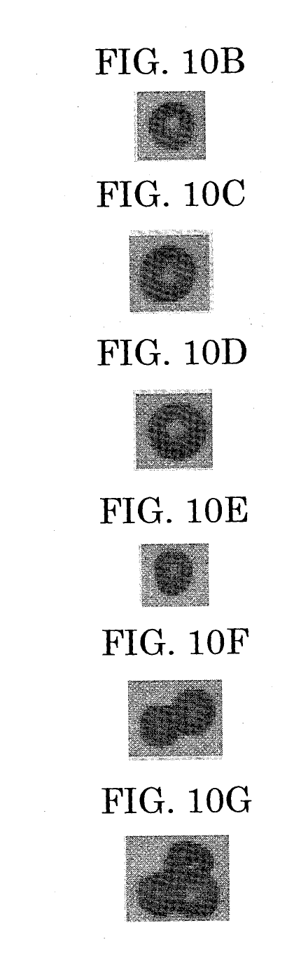

When toner particles are dried in a gas phase and collected with a cyclone, but when the collected particles have been dried insufficiently in the gas phase and remain contacting each other for a continued period, there occurs a phenomenon that the particles couple with each other while being substantially kept in their respective shapes as shown in FIG. 10E to FIG. 10G (hereinafter, this phenomenon is referred to as binding). This is because toner particles in which binder resins are used are greatly plasticized because of any residual solvent in the particles. When such a binding occurs, the particles are not detached from each other even when a mechanical strength is applied, and the toner particles behave as large particles. Further, the particle shape becomes greatly different from a sphere, and is not desirable for images in an electrophotography system. For such reasons, binding is unfavorable.

In order to prevent binding, it is necessary to accelerate the speed at which the solvent is dried. It is possible to accelerate the drying of the solvent by reducing the molecular weight of the resins.

As additives for the toner of the present invention, various types of metal soaps, fluorosurfactant, and dioctyl phthalate may be added for protection of an electrostatic latent image bearing member and a carrier, improvement of cleanability, adjustment of thermal properties, electric properties, and physical properties, adjustment of resistance, adjustment of softening point, and improvement of fixability, and tin oxide, zinc oxide, carbon black, antimony oxide, etc., and inorganic fine particles such as titanium oxide, aluminum oxide, and alumina may be added as an electro-conductivity imparting agent according to necessity. These inorganic particles may be hydrophobized according to necessity. Further, a lubricant such as polytetrafluoroethylene, zinc stearate, and polyvinylidene fluoride, an abrading agent such as cesium oxide, silicon carbide, and strontium titanate, a caking inhibitor, and as a developability improver, white fine particles and black fine particles having a polarity opposite to the toner particles may be used in a small amount.

It is also preferable to treat these additives with silicone varnish, various types of modified silicone varnishes, silicone oil, various types of modified silicone oils, silane coupling agent, silane coupling agent containing a functional group, treating agent made of any other organosilicon compound, or various types of treating agent, for the purposes of controlling the amount of charge buildup.

Inorganic fine particles can be preferably used as the additives. Publicly-known particles such as silica, alumina, and titanium oxide can be used as the inorganic fine particles.

Other examples include polycondensed thermosetting-resin-made polymer particles obtained by, for example, soap-free emulsion polymerization, suspension polymerization, and dispersion polymerization, such as polystyrene, methacrylic acid ester, acrylic acid ester copolymer, silicone, benzoguanamine, and nylon.

Hydrophobicity of these additives can be increased with a surface preparation agent, so that the additives can be prevented from degradation under high humidity conditions. Preferable examples of the surface preparation agent include silane coupling agent, silylation agent, silane coupling agent containing an alkyl fluoride group, organic titanate-based coupling agent, aluminum-based coupling agent, silicone oil, and modified silicone oil.

The primary particle diameter of the additives is preferably from 5 [nm] to 2 [μm], and more preferably from 5 [nm] to 500 [nm]. The specific surface area of the additives according to BET method is preferably from 20 [m²/g] to 500 [m²/g]. The percentage of use of the inorganic fine particles is preferably from 0.01 [% by mass] to 5 [% by mass], and more preferably from 0.01 [% by mass] to 2.0 [% by mass] of the toner.

Examples of the cleanability improver for removing the developer remained after transfer on the electrostatic latent image bearing member or a first transfer medium include: fatty acid metal salt such as zinc stearate, calcium stearate, and stearic acid; and polymer fine particles produced by soap free emulsion polymerization such as polymethyl methacrylate fine particles and polystyrene fine particles. The polymer fine particles preferably have a relatively narrow particle size distribution, and a volume average particle diameter of from 0.01 [μm] to 1 [μm].

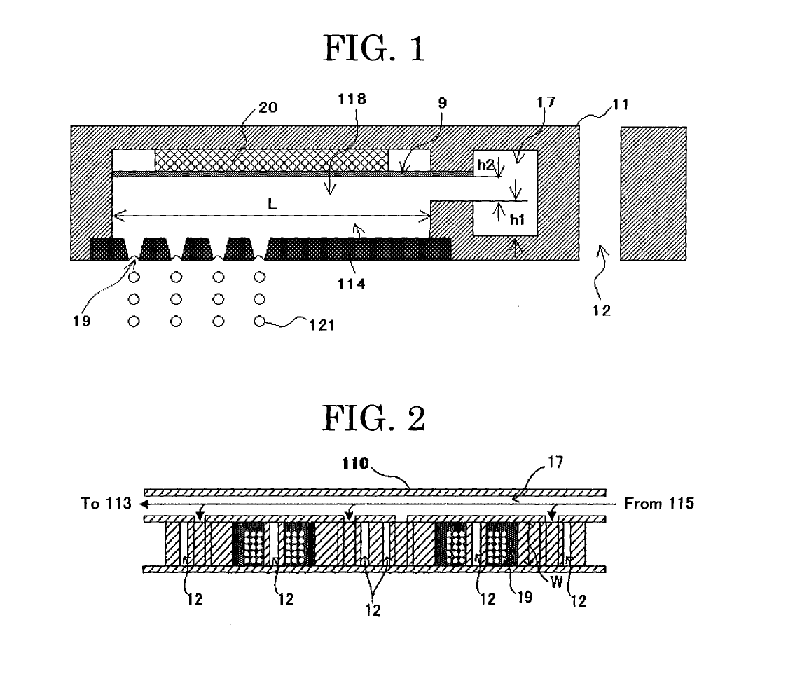

Next, a toner producing method will be explained. The toner of the present invention can be produced in a hydrophobic medium. One example of a producing unit of the toner of the present invention will be explained with reference to FIG. 1 to FIG. 8.

In the present invention, the toner producing unit is of a jet granulating method, but is not limited to this producing method, because the principle described in this specification is applicable for any method as long as it is for producing a toner in a hydrophobic medium. The jet granulating unit is divided into a liquid droplet discharging unit and a liquid droplet solidifying/collecting unit. Each will be described below.

### [Liquid Droplet Discharging Unit]

The liquid droplet discharging unit used in the present invention is not particularly limited and may be a publicly-known one as long as it discharges liquid droplets having a narrow particle size distribution. Examples of the liquid droplet discharging unit include one fluid nozzle, two fluid nozzles, a membrane oscillation type discharging unit, a Rayleigh breakup type discharging unit, a liquid oscillation type discharging unit, and a liquid column resonance type discharging unit. A membrane oscillation type liquid droplet discharging unit is described in, for example, JP-A No. 2008-292976. A Rayleigh breakup type liquid droplet discharging unit is described in, for example, JP-B No. 4647506. A liquid oscillation type liquid droplet discharging unit is described in, for example, JP-A No. 2010-102195.

To make the particle size distribution of the liquid droplets narrow and secure toner productivity at the same time, it is possible to utilize, for example, liquid drop forming liquid column resonance. In liquid droplet forming liquid column resonance, a vibration is applied to a liquid in a liquid column resonance liquid chamber to form a standing wave based on a liquid column resonance, so that the liquid may be discharged from a plurality of discharge holes formed in a region corresponding to an anti-node region of the standing wave.

### [Liquid Column Resonance Discharging Unit]

A liquid column resonance type discharging unit configured to discharge droplets by utilizing resonance of a liquid column will be explained.

FIG. 1 shows a liquid column resonance liquid droplet discharging unit 11. It includes a common liquid supply path 17 and a liquid column resonance liquid chamber 118. The liquid column resonance liquid chamber 118 communicates with the common liquid supply path 17 formed at one of longer-direction wall surfaces on both sides. The liquid column resonance liquid chamber 118 includes discharge holes 19 for discharging liquid droplets 121, which are formed in one of wall surfaces that connect with the wall surfaces on both sides, and a vibration generating unit 20 provided on a wall surface opposite to the wall surface in which the discharge holes 19 are formed and configured to generate a high frequency vibration in order to form a liquid column resonance standing wave. An unillustrated high frequency power source is connected to the vibration generating unit 20.

In the present invention, a liquid that contains the components for forming the toner particles is referred to as “toner composition liquid”. The toner composition liquid is discharged from the discharging unit, and needs only to be in a liquid state under the discharging conditions. That is, the toner composition liquid may be in a dispersed state in which the components of the toner particles to be obtained are dissolved or dispersed, or may be in a solvent-free toner particle component melted state.

The toner composition liquid 114 flows through a liquid supply pipe by an unillustrated liquid circulating pump, flows into the common liquid supply path 17 of a liquid column resonance liquid droplet forming unit 110 shown in FIG. 2, and is supplied into the liquid column resonance liquid chamber 118 of the liquid column resonance liquid droplet discharging unit 11 shown in FIG. 1. A pressure distribution is formed in the liquid column resonance liquid chamber 118 filled with the toner composition liquid 114, due to a liquid column resonance standing wave generated by the vibration generating unit 20. Then, liquid droplets 121 are discharged from the discharge holes 19 which are located in a region corresponding to an anti-node region of the standing wave in which the liquid column resonance standing wave has high amplitudes and large pressure pulsation. An anti-node region of the liquid column resonance standing wave means a region other than a node of the standing wave. It is preferably a region in which the pressure pulsation of the standing wave has high amplitudes enough to discharge the liquid, and more preferably a region including regions that are on both sides of a position at which the amplitude of the pressure standing wave reaches a local maximum (i.e., a node of the velocity standing wave) and that are within ¼, as measured from the local maximum, of the wavelength extending from the local maximum of the amplitude to local minimums thereof.

Even when a plurality of discharge holes are formed, as long as they are formed within a region corresponding to an anti-node of the standing wave, substantially uniform liquid droplets can be formed from the respective discharge holes. Moreover, liquid droplets can be discharged efficiently, and the discharge holes are less likely to be clogged. The toner composition liquid 114 having flowed through the common liquid supply path 17 is returned to a raw material container through an unillustrated liquid returning pipe. When the amount of the toner composition liquid 114 in the liquid column resonance liquid chamber 118 decreases by the discharging of the liquid droplets 121, a suction power acts due to the effect of the liquid column resonance standing wave in the liquid column resonance liquid chamber 118, to thereby increase the flow rate of the toner composition liquid 114 to be supplied from the common liquid supply path 17. As a result, the liquid column resonance liquid chamber 118 is refilled with the toner composition liquid 114. When the liquid column resonance liquid chamber 118 is refilled with the toner composition liquid 114, the flow rate of the toner composition liquid 114 flowing through the common liquid supply path 17 returns to as before.

The liquid column resonance liquid chamber 118 of the liquid column resonance liquid droplet discharging unit 11 is formed by joining together frames each made of a material having stiffness high but uninfluential for the liquid resonance frequency at a driving frequency, such as metal, ceramics, and silicon. Further, as shown in FIG. 1, the length L between both of the longer-direction wall surfaces of the liquid column resonance liquid chamber 118 is determined based on a liquid column resonance principle described later. The width W of the liquid column resonance liquid chamber 118 shown in FIG. 2 is preferably smaller than ½ of the length L of the liquid column resonance liquid chamber 118, so as not to give any extra frequency to the liquid column resonance. Further, it is preferable to provide a plurality of liquid column resonance liquid chambers 118 in one liquid column resonance liquid droplet forming unit 110, in order to improve the productivity drastically. The number of the liquid chambers 118 is not limited, but one liquid droplet forming unit including 100 to 2,000 liquid column resonance liquid chambers 118 is the most preferable, because operability and productivity can both be satisfied. A liquid supply path that leads from the common liquid supply path 17 is connected to each liquid column resonance liquid chamber, and the common liquid supply path 17 hence communicates with the plurality of liquid column resonance liquid chamber 118.

The vibration generating unit 20 of the liquid column resonance liquid droplet discharging unit 11 is not particularly limited as long as it can be driven at a predetermined frequency, but one that is obtained by pasting a piezoelectric element on an elastic plate 9 is preferable. The elastic plate constitutes part of the wall of the liquid column resonance liquid chamber in order to prevent the piezoelectric element from contacting the liquid. The piezoelectric element may be, for example, piezoelectric ceramics such as lead zirconate titanate (LZT), and is often used in the form of a laminate because the amount of displacement is small. Other examples thereof include piezoelectric polymer such as polyvinylidene fluoride (PVDF), and monocrystals such as crystal, LiNbO₃, LiTaO₃, and KNbO₃. Further, the vibration generating unit 20 is preferably provided such that it can be controlled individually per liquid column resonance liquid chamber. Further, the vibration generating unit is preferably a block-shaped vibration member made of one of the above materials and partially cut according to the geometry of the liquid column resonance liquid chamber, so that it is possible to control each liquid column resonance liquid chamber individually via the elastic plate.

The diameter of the opening of the discharge hole 19 is preferably from 1 [μm] to 40 [μm]. When the diameter is 1 [μm] or greater, the liquid droplet can be prevented from being too small, and a liquid droplet having an adequate size can be formed. Further, even when solid fine particles of a pigment, etc. are added as a toner constituent component, the discharge holes 19 may not be clogged, and the productivity can be enhanced. When the diameter is 40 [μm] or less, the diameter of the liquid droplet can be prevented from being too large. This makes it possible to obtain a desired toner particle diameter of from 3 μm to 6 μm by drying and solidifying the toner composition liquid without having to dilute it greatly. There may be cases when it is necessary to dilute the toner composition to a very thin liquid with an organic solvent. Therefore, the amount of the organic solvent used for the dilution can be reduced, and the drying energy necessary for obtaining a predetermined amount of toner can be saved. Further, it is preferable to employ the configuration of arranging the discharge holes 19 in the direction of width of the liquid column resonance liquid chamber 118 as can be seen from FIG. 2, because this makes it possible to provide many discharge holes 19, and hence improves the production efficiency. Further, because the liquid column resonance frequency varies depending on the arrangement of the openings of the discharge holes 19, it is preferable to determine the liquid column resonance frequency appropriately by confirming liquid droplet discharging.

The cross-sectional shape of the discharge hole 19 is illustrated in FIG. 1, etc. as a taper shape with which the diameter of the opening decreases. However, an appropriate cross-sectional shape may be selected.

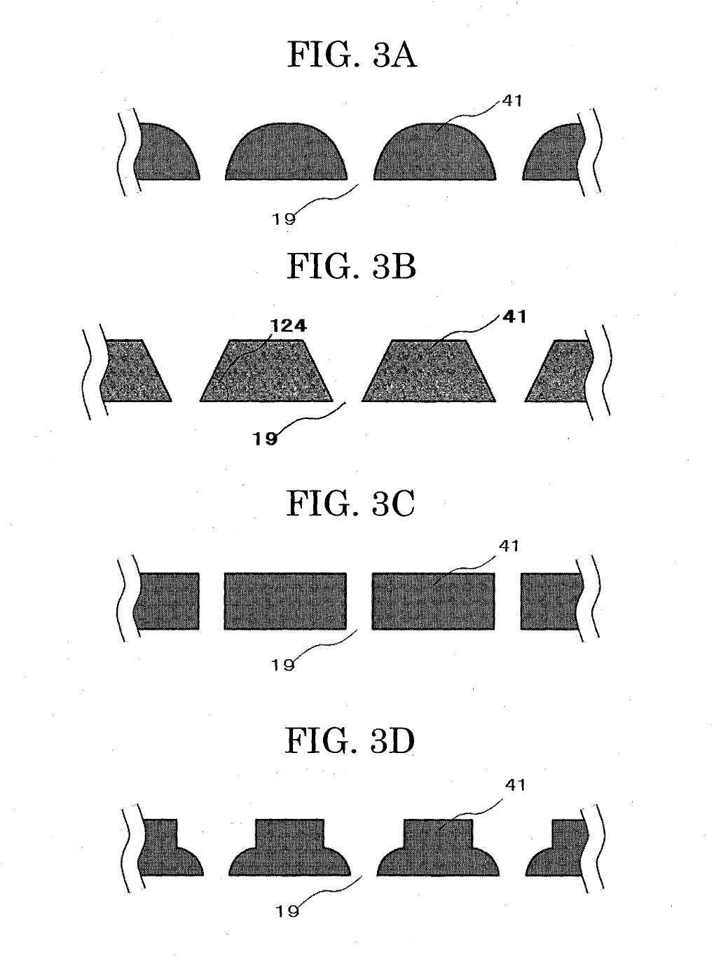

FIG. 3A to FIG. 3D show possible cross-sectional shapes of the discharge hole 19.

In the cross-sectional shape shown in FIG. 3A, the discharge hole 19 is round from its surface contacting the liquid to the discharge exit, while reducing the diameter of the opening. With this shape, the pressure to be applied on the liquid when a thin film 41 vibrates becomes the maximum at about the exit of the discharge hole 19. Therefore, this shape is the most preferable shape for discharging stabilization.

In the cross-sectional shape shown in FIG. 3B, the diameter of the opening decreases from the liquid contacting surface of the discharge hole 19 to the discharge exit at a constant angle. This nozzle angle 124 may be changed appropriately. With this nozzle angle, it is possible for the pressure, which is to be applied on the liquid when the thin film 41 vibrates, to be high at about the exit of the discharge hole 19, like the shape of FIG. 3A. This angle is preferably from 60° to 90°. An angle of 60° or less is unfavorable, because it is difficult to pressurize the liquid at such an angle, and it is also difficult to fabricate the thin film 41 to have such an angle.

The cross-sectional shape shown in FIG. 3C corresponds to the shape of FIG. 3B in which the nozzle angle 124 is 90°. An angle of 90° is the largest possible value, because it becomes harder to pressurize the exit at any larger angle. When the angle is 90° or greater, no pressure is applied to the exit of the discharge hole 19, and liquid droplet discharging becomes very unstable.

The cross-sectional shape shown in FIG. 3D is a shape obtained by combining the cross-sectional shape of FIG. 3A and the cross-sectional shape of FIG. 3B. It is possible to make a stepwise change to the shape in this way.

Next, the mechanism by which the liquid droplet forming unit forms liquid droplets based on liquid column resonance will be explained.

First, the principle of the liquid column resonance phenomenon that occurs in the liquid column resonance liquid chamber 118 of the liquid column resonance liquid droplet discharging unit 11 shown in FIG. 1 will be explained.

When the sound velocity of the toner composition liquid in the liquid column resonance liquid chamber is c, and the driving frequency applied by the vibration generating unit 20 to the toner composition liquid serving as a medium is f, the wavelength λ at which a resonance of the liquid occurs is in the relationship of

λ=c/f (Formula 1).

In the liquid column resonance liquid chamber 118 of FIG. 1, the length from a frame end at the fixed end side to the end at the common liquid supply path 17 side is L, the height h1 (=about 80 [μm] of the frame end at the common liquid supply path 17 side is about double the height h2 (=about 40 [μm]) of a communication port, and it is assumed that this end is equivalent to a closed fixed end. When both ends are fixed like this, a resonance is formed the most efficiently when the length L corresponds to an even multiple of ¼ of the wavelength λ. This is expressed by the following formula 2.

L=(N/4)λ (Formula 2)

(where N is an even number.)

The above formula 2 can also be established in the case of both-side free ends, where both ends are completely opened.

Likewise, when one end is equivalent to a free end that allows the pressure to escape, and the other end is closed (fixed end), i.e., in the case of one-side fixed end or one-side free end, a resonance is formed the most efficiently when the length L corresponds to an odd multiple of ¼ of the wavelength λ. That is, the value N in the above formula 2 is represented by an odd number.

The most efficient driving frequency f is derived from the above formulae 1 and 2 as

f=N×c/(4L) (Formula 3).

However, actually, the vibration is not amplified unlimitedly, because the liquid has viscosity that may attenuate the resonance. The liquid has the Q-value, and also resonates at a frequency close to the most efficient driving frequency f expressed by the formula 3, as shown by formulae 4 and 5 described below.

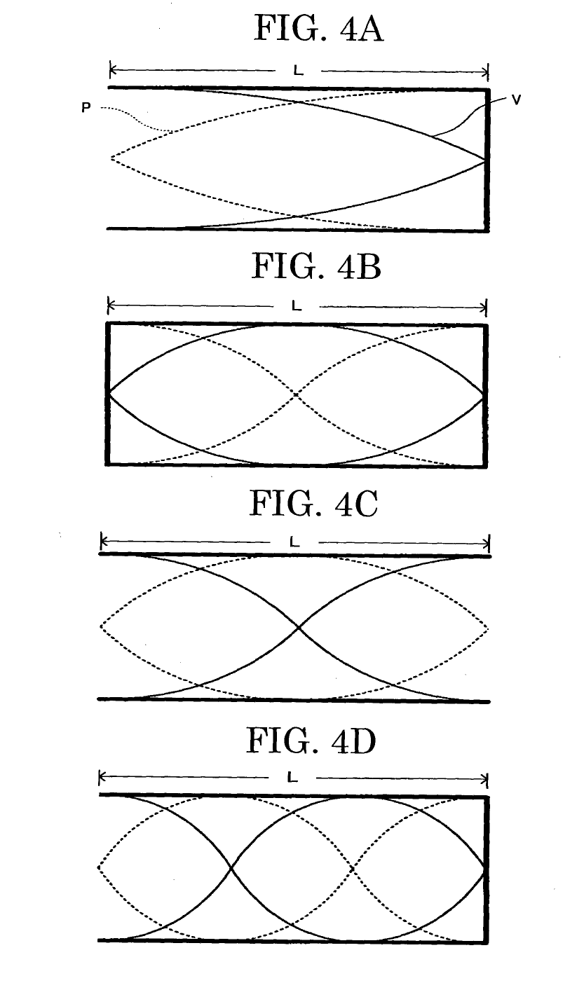

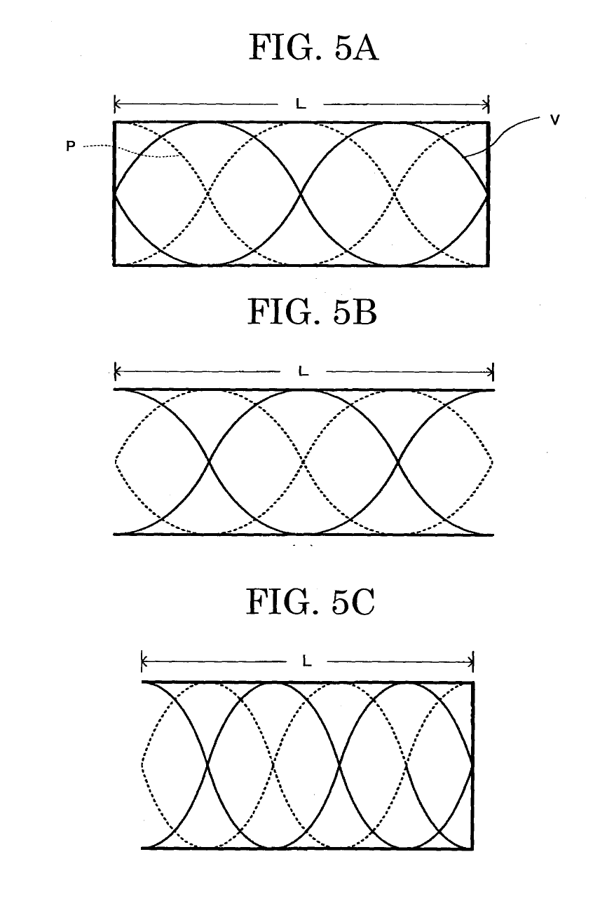

FIG. 4A to FIG. 4D show the shapes of standing waves of velocity and pressure pulsation (resonance mode) when N=1, 2, and 3. FIG. 5A to FIG. 5C show the shapes of standing waves of velocity and pressure pulsation (resonance mode) when N=4 and 5. Although a standing wave is basically a compression wave (longitudinal wave), it is commonly expressed as in FIG. 4A to FIG. 4D and FIG. 5A to FIG. 5C. The solid line is a velocity standing wave, and a dotted line is a pressure standing wave. For example, as can be seen from FIG. 4A showing a case of one-side fixed end where N=1, the amplitude of the velocity distribution is zero at the closed end, and the maximum at the free end, and hence the velocity distribution is understandable intuitively. When the length between the longer-direction both ends of the liquid column resonance liquid chamber is L and the wavelength of a liquid column resonance of the liquid is λ, a standing wave occurs the most efficiently when N=1 to 5. Further, the pattern of a standing wave varies depending on whether both ends are closed or opened. Therefore, these information are also described in the drawings. As will be described later, the conditions of the ends are determined depending on the state of the openings of the discharge holes and the state of the opening of the supplying side.

In the acoustics, an opened end is a longer-direction end at which the moving velocity of the medium (liquid) reaches a local maximum, and at which the pressure reaches a local minimum to the contrary. Conversely, a closed end is defined as an end at which the moving velocity of the medium is zero. A closed end is considered an acoustically hard wall, which reflects a wave. When an end is ideally perfectly closed or opened, a resonance standing wave as shown in FIG. 4A to FIG. 4D and FIG. 5A and FIG. 5C occurs by superposition of waves. However, the pattern of a standing wave varies depending also on the number of discharge holes and the positions at which the discharge holes are opened, and hence a resonance frequency appears in a region shifted from a region derived from the above formula 3. In this case, it is possible to create stable discharging conditions by appropriately adjusting the driving frequency. For example, when a sound velocity of the liquid of 1,200 [m/s] and a length L of the liquid column resonance liquid chamber of 1.85 [mm] are used, and a resonance mode completely equivalent to both-side fixed ends with walls present on both ends, where N=2, is used, the most efficient resonance frequency is derived as 324 kHz from the above formula 2. In another example in which the same conditions as above, i.e., the sound velocity of the liquid of 1,200 [m/s] and the length L of the liquid column resonance liquid chamber of 1.85 [mm] are used, and a resonance mode equivalent to both-side fixed ends with walls present on both ends, where is used, the most efficient resonance frequency is derived as 648 kHz from the above formula 2. Like this, a lower-order resonance and a higher-order resonance can both be utilized in the same liquid column resonance liquid chamber.

In order to increase the frequency, it is preferable that the liquid column resonance liquid chamber of the liquid column resonance liquid droplet discharging unit 11 shown in FIG. 1 have a state equivalent to a closed end state at both ends, or have ends that could be described as acoustically soft walls owing to influences from the openings of the discharge holes. However, this is not limiting, and the ends may be free ends. Here, the influences from the openings of the discharge holes mean that there is a smaller acoustic impedance, and particularly that there is a larger compliance component. Therefore, a configuration as shown in FIG. 4B and FIG. 5A, in which walls are formed at longer-direction both ends of the liquid column resonance liquid chamber, is preferable, because resonance modes of both-side fixed ends and all resonance modes of one-side free end in which the discharge hole side is regarded as being opened, can be used in such a configuration.

The number of openings of the discharge holes, the positions at which the openings are formed, and the cross-sectional shape of the discharge holes are also the factors that determine the driving frequency. The driving frequency can be appropriately determined based on these factors. For example, when the number of discharge holes is increased, the fixed end of the liquid column resonance liquid chamber gradually becomes less unfree, and a resonance standing wave that is substantially the same as a standing wave in the case of an opened end will occur. Therefore, the driving frequency will be high. Further, the unfree condition becomes weaker, as starting from the position at which the discharge hole the closest to the liquid supply path is opened. The cross-sectional shape of the discharge hole may be changed to a round shape, or the volume of the discharge hole may be changed based on the thickness of the frame. Hence, actually, the wavelength of a standing wave may be short, and the frequency thereof may be higher than the driving frequency. When a voltage is applied to the vibration generating unit at the driving frequency determined in this way, the vibration generating unit deforms, and a resonance standing wave occurs the most efficiently at the driving frequency. A liquid column resonance standing wave also occurs at a frequency close to the driving frequency at which a resonance standing wave occurs the most efficiently. That is, when the length between the longer-direction both ends of the liquid column resonance liquid chamber is L and the distance to the discharge hole that is the closest to the liquid supply side end is Le, it is possible to induce a liquid column resonance and discharge liquid droplets from the discharge holes, by vibrating the vibration generating unit with a driving waveform, of which main component is the driving frequency f, which is in the range determined by the formulae 4 and 5 below using L and Le.

N×c/(4L)≦f≦N×c/(4Le) (Formula 4)

N×c/(4L)≦f≦(N+1)×c/(4Le) (Formula 5)

It is preferable that the ratio between the length L between the longer-direction both ends of the liquid column resonance liquid chamber and the distance Le to the discharge hole that is the closest to the liquid supply side end satisfy Le/L>0.6.

Based on the principle of the liquid column resonance phenomenon described above, a liquid column resonance pressure standing wave is formed in the liquid column resonance liquid chamber 118 of FIG. 1, and liquid droplet discharging occurs continuously from the discharge holes 19 provided in a portion of the liquid column resonance liquid chamber 118. It is preferable to provide the discharge holes 19 at a position at which the pressure of the standing wave reaches the maximum pulsation, because this improves the discharging efficiency and allows driving at a lower voltage. Further, the number of discharge holes 19 may be one in one liquid column resonance liquid chamber 118. However, it is preferable to provide a plurality of discharge holes in terms of productivity. Specifically, the number of discharge holes is preferably from 2 to 100.

By providing 100 or less discharge holes, it is possible to suppress the voltage to apply to the vibration generating unit 20 for forming desired liquid droplets from the discharge holes 19 to a low level, which makes it possible to stabilize the behavior of the piezoelectric element as the vibration generating unit 20. In the formation of a plurality of discharge holes 19, the pitch between the discharge holes is preferably from 20 [μm] to equal to or shorter than the length of the liquid column resonance liquid chamber. By setting the pitch between the discharge holes to 20 [μm] or greater, it is possible to suppress the possibility that liquid droplets discharged from adjoining discharge holes will collide on each other to form a larger droplet, which makes it possible to obtain a favorable toner particle size distribution.

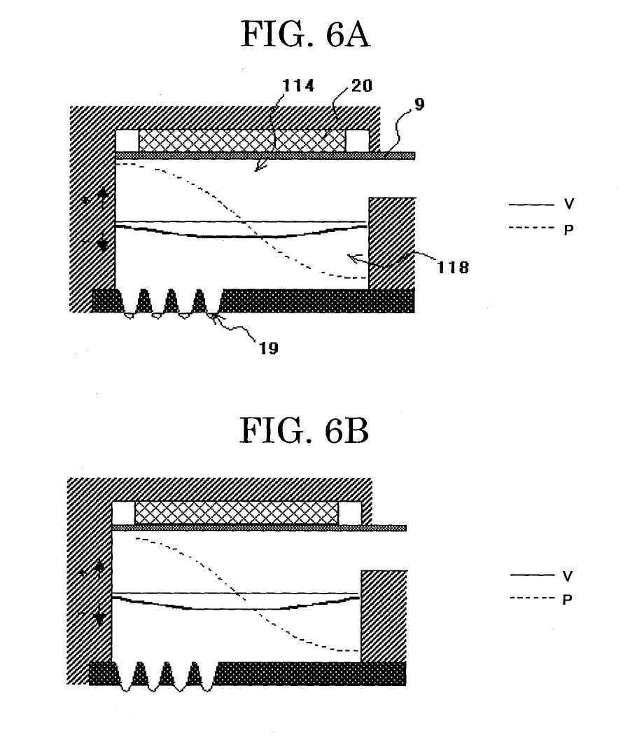

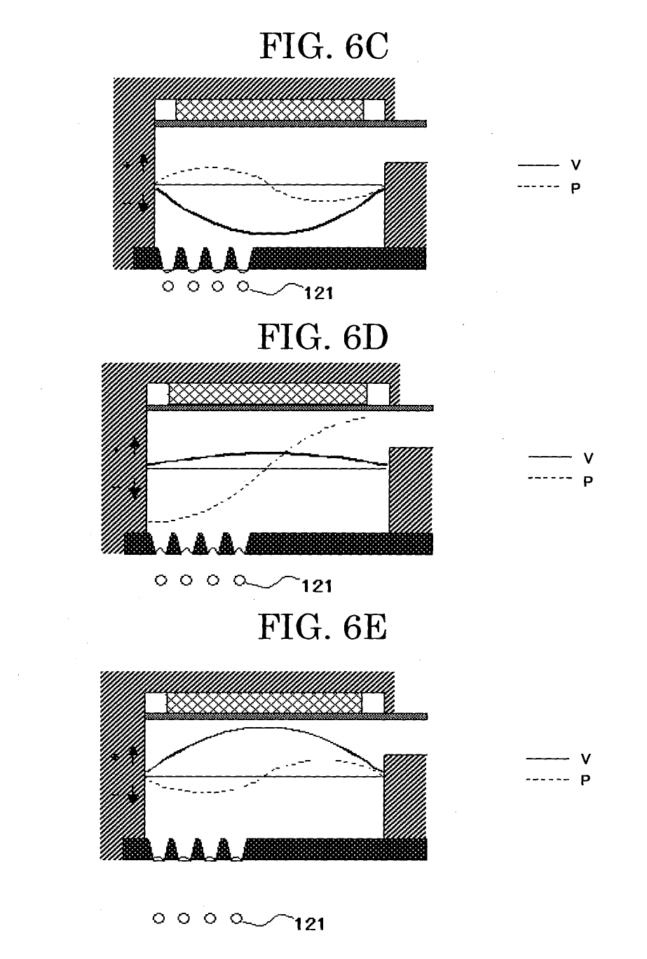

Next, a liquid column resonance phenomenon that occurs in the liquid column resonance liquid chamber in a liquid droplet discharging head of the liquid droplet forming unit will be described with reference to FIG. 6A to FIG. 6E which show this phenomenon. In these diagrams, the solid line drawn in the liquid column resonance liquid chamber represents a velocity distribution plotting the velocity at the respective arbitrary measuring positions from the fixed end of the liquid column resonance liquid chamber to the common liquid supply side end thereof. The direction from the common liquid supply path to the liquid column resonance liquid chamber is +, and the opposite direction is −. The dotted line drawn in the liquid column resonance liquid chamber represents a pressure distribution plotting the pressure values at respective arbitrary measuring positions from the fixed end of the liquid column resonance liquid chamber to the common liquid supply path side end thereof. With respective to the atmospheric pressure, a positive pressure is +, and a negative pressure is −.

When the pressure is positive, the pressure is applied downwards in the diagrams. When the pressure is negative, the pressure is applied upwards in the diagrams. Further, in these diagrams, the common liquid supply path side is opened, and the height of a frame serving as the fixed end (the height h1 shown in FIG. 1) is about double or more the height of the opening (the height h2 shown in FIG. 1) through which the common liquid supply path 17 and the liquid column resonance liquid chamber 118 communicate with each other. Therefore, FIG. 6A to FIG. 6E show the temporal changes of the velocity distribution and pressure distribution under an approximate condition where the liquid column resonance liquid chamber 118 is substantially fixed at both ends.

FIG. 6A shows a pressure waveform and a velocity waveform in the liquid column resonance liquid chamber 118 at the time of discharging liquid droplets. In FIG. 6B, the meniscus pressure builds up again after the liquid is withdrawn after the liquid droplets are discharged. As shown in FIG. 6A and FIG. 6B, the pressure reaches a local maximum in a flow path in which the discharge holes 19 of the liquid column resonance liquid chamber 118 are provided. After this, as shown in FIG. 6C, the positive pressure near the discharge holes 19 lowers to shift to a negative pressure side, and liquid droplets 121 are discharged.

Then, as shown in FIG. 6D, the pressure near the discharge holes 19 reaches a local minimum. From this instant, the liquid column resonance liquid chamber 118 starts to be filled with the toner composition liquid 114. After this, as shown in FIG. 6E, the negative pressure near the discharge holes 19 lowers to shift to a positive pressure side. At this instant, the liquid chamber is filled up with the toner composition liquid 114. Then, as shown in FIG. 6A, the positive pressure in the liquid droplet discharging region of the liquid column resonance liquid chamber 118 reaches a local maximum again, and liquid droplets 121 are discharged from the discharge holes 19. In this way, a standing wave based on a liquid column resonance occurs in the liquid column resonance liquid chamber by the vibration generating unit being driven at a high frequency. Since the discharge holes 19 are provided in the liquid droplet discharging region corresponding to the anti-node of the liquid column resonance standing wave at which the pressure pulsation reaches the maximum, liquid droplets 121 are continuously discharged from the discharge holes 19 synchronously with the cycle of the anti-node.

### [Solidification of Liquid Droplets]

The toner of the present invention can be obtained by solidifying and then collecting the liquid droplets of the toner composition liquid discharged into a gas from the above-described liquid droplet discharging unit.

### [Liquid Droplet Solidifying Unit]

The method for solidifying the liquid droplets may be arbitrary, basically as long as it can bring the toner composition liquid into a solid state, although the idea may be different depending on the characteristics of the toner composition liquid.

For example, when the toner composition liquid is one that is obtained by dissolving or dispersing the solid raw materials in a volatile solvent, it is possible to solidify the liquid droplets by drying the liquid droplets in a conveying air stream, i.e., by volatilizing the solvent after the liquid droplets are jetted. For drying the solvent, it is possible to adjust the dry state, by selecting the temperature and vapor pressure of the gas to be jetted, the type of the gas, etc. appropriately. The collected particles need not be dried completely, and as long as they retain a solid state, they can be additionally dried in a separate step after collected. This method is not obligatory, and the liquid droplets may be solidified by temperature change, application of a chemical reaction, etc.

### [Solidified Particle Collecting Unit]

The solidified particles can be collected from the gas with a publicly-known powder collecting unit such as a cyclone collector and a back filter.

FIG. 7 is a cross-sectional diagram of an example of an apparatus that carries out the toner producing method of the present invention. The toner producing apparatus 1 mainly includes a liquid droplet discharging unit 2 and a drying/collecting unit 160.

A raw material container 113 that contains the toner composition liquid 114, and a liquid circulating pump 115 are joined to the liquid droplet discharging unit 2. The liquid circulating pump is configured to supply the toner composition liquid 114 contained in the raw material container 113 into the liquid droplet discharging unit 2 through a liquid supply pipe 116 and to pneumatically convey the toner composition liquid 114 in the liquid supply pipe 116 in order to return the toner composition liquid into the raw material container 113 through a liquid returning pipe 122. The toner composition liquid 114 can be supplied into the liquid droplet discharging unit 2 at any time. A pressure gauge P1 is provided on the liquid supply pipe 116, and a pressure gauge p2 is provided on the drying/collecting unit. The pressure at which the liquid is fed into the liquid droplet discharging unit 2 is managed by the pressure gauge P1, and the pressure in the drying/collecting unit is managed by the pressure gauge P2. In this case, when P1>P2, there is a risk that the toner composition liquid 114 may exude from the discharge holes 19. When P1<P2, there is a risk that a gas may be let into the discharging unit and stop the discharging. Therefore, it is preferable that P1≈P2.

A descending air stream (a conveying air stream) 101 is formed in a chamber 161 from a conveying air stream inlet port 164. The liquid droplets 121 discharged from the liquid droplet discharging unit 2 are conveyed downward not only by the gravitational force but also by the conveying air stream. 101, get out through a conveying air stream outlet 165, and are collected by a solidified particle collecting unit 162 and stored in a solidified particle storing unit 163.

### [Conveying Air Stream]

If the jetted liquid droplets contact each other before dried, they merge as one particle (hereinafter, this phenomenon is referred to as merging). In order to obtain solidified particles having a uniform particle size distribution, it is necessary to keep the jetted liquid droplets at a distance from each other. However, the jetted liquid droplets that have a certain initial velocity lose speed after a while due to the air resistance. The particles having lost speed are caught up with by the liquid droplets jetted afterwards, and they merge with each other as a result. FIG. 10A to FIG. 10D show the state and the particle diameter of a merged particle captured with a flow-type particle image analyzer (FPIA-3000 manufactured by Sysmex Corporation).

Because this phenomenon occurs constantly, the particle size distribution of the particles collected in this state is very poor. In order to prevent merging, it is necessary to convey and solidify the liquid droplets, while preventing the velocity of the liquid droplets from slowing down and the liquid droplets from contacting each other with the conveying air stream 101 to thereby prevent merging. Eventually, the solidified particles are conveyed to the solidified particle collecting unit.

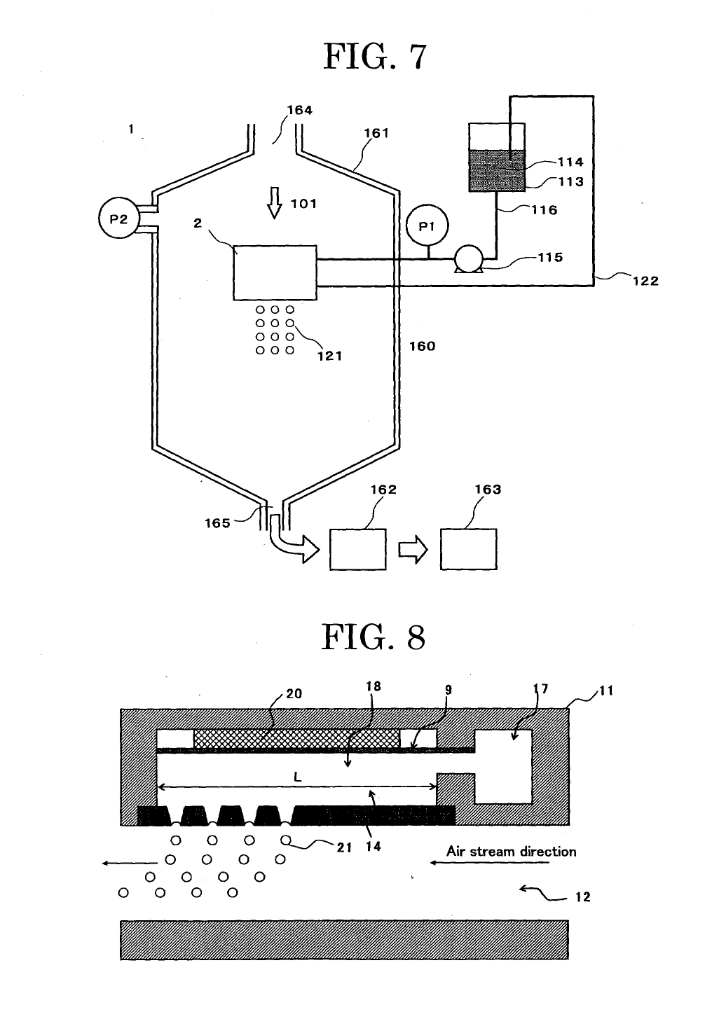

For example, as shown in FIG. 7, by providing a portion of the conveying air stream 101 as a first air stream in the vicinity of the liquid droplet discharging unit in the same direction as the liquid droplet discharging direction, it is possible to prevent the velocity of the liquid droplets from slowing down immediately after the liquid droplets are discharged and thereby prevent merging. Alternatively, the merging preventing air stream may be transverse to the discharging direction as shown in FIG. 8. Alternatively, although not illustrated, the air stream may have an angle, and the angle is preferably an angle at which the liquid droplets will be dragged away from the liquid droplet discharging unit. When the merging preventing air stream is supplied transversely to the discharging of the liquid droplets as in FIG. 8, the direction of the merging preventing air stream is preferably a direction in which the liquid droplets will not leave a locus when conveyed by the air stream.

After merging is prevented with the first air stream as described above, the solidified particles may be conveyed to the solidified particle collecting unit with a second air stream.

The velocity of the first air stream is preferably equal to or higher than the velocity at which the liquid droplets are jetted. When the velocity of the merging preventing air stream is lower than the liquid droplet jetting velocity, it is difficult to exert the function of preventing the liquid droplet particles from contacting each other, which is the essential object of the merging preventing air stream.

In terms of characteristics, the first air stream may further be conditioned so as to prevent merging of the liquid droplets, and needs not necessarily be the same as the second air stream. Further, a chemical substance that promotes solidification of the surface of the particles may be mixed in the merging preventing air stream, or may be imparted to the air stream in anticipation of a physical effect.

The conveying air stream 101 is not particularly limited in terms of the state as an air stream, and may be a laminar flow, a swirl flow, or a turbulent flow. The kind of the gas to compose the conveying air stream 101 is not particularly limited, and may be air, or an incombustible gas such as nitrogen. The temperature of the conveying air stream 101 may be adjusted appropriately, and it is preferable that the conveying air stream not undergo temperature fluctuation during production. The chamber 161 may have a unit configured to change the air stream state of the conveying air stream 101. The conveying air stream 101 may be used not only for preventing the liquid droplets 121 from merging but also for preventing them from depositing on the wall surface of the chamber 161.

### [Second Drying]

When the toner particles obtained by the drying/collecting unit shown in FIG. 7 contain a large amount of residual solvent, second drying is performed in order to reduce the amount of residual solvent according to necessity. For the second drying, a common publicly-known drying method such as fluid bed drying and vacuum drying may be used. When the organic solvent remains in the toner, not only toner characteristics such as heat resistant storage stability, fixability, and charging property may change over time, but also the residual solvent may volatilize during fixing by heating, which increases the possibility that the user and peripheral devices will receive adverse influences. Therefore, sufficient drying is performed.

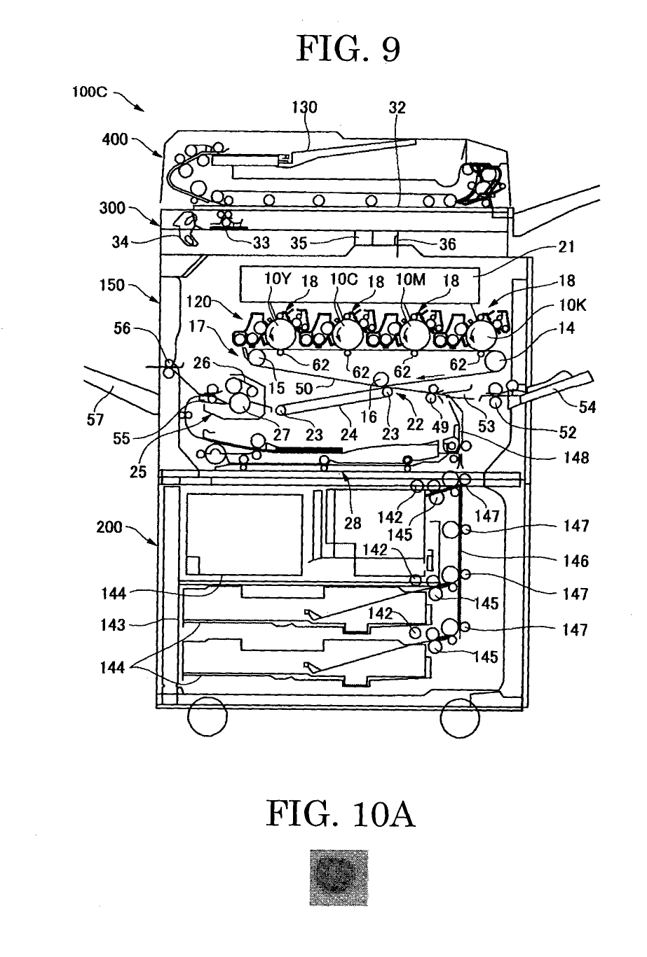

The toner of the present invention is used for, for example, a tandem full-color image forming apparatus shown in FIG. 9.

The tandem full-color image forming apparatus 100C shown in FIG. 9 includes a copier body 150, a sheet feeding table 200, a scanner 300, and an automatic document feeder (ADF) 400.

An endless-belt-shaped intermediate transfer member 50 is provided in the center of the copier body 150. The intermediate transfer member 50 is tensed by support rollers 14, 15, and 16, and can rotate clockwise in FIG. 9. An intermediate transfer member cleaning device 17 configured to remove residual toner on the intermediate transfer member 50 is provided near the support roller 15. The intermediate transfer member 50 tensed by the support roller 14 and the support roller 15 is provided thereon with a tandem developing device 120 including four image forming unit 18 for yellow, cyan, magenta, and black, which face the intermediate transfer member and are arranged side by side along the conveying direction of the intermediate transfer member. An exposing device 21 as an exposing member is provided near the tandem developing device 120. A second transfer device 22 is provided on a side of the intermediate transfer member 50 that is opposite from the side thereof on which the tandem developing device 120 is provided. In the second transfer device 22, a second transfer belt 24, which is an endless belt, is tensed by a pair of rollers 23. A transfer sheet conveyed over the second transfer belt 24 and the intermediate transfer member 40 can contact each other. A fixing device 25 as a fixing unit is provided near the second transfer device 22. The fixing device 25 includes a fixing belt 26, which is an endless belt, and a pressurizing roller. 27 provided pushed against the belt.

In the tandem image forming apparatus, a sheet overturning device 28 configured to overturn a transfer sheet in order for images to be formed on both sides of the transfer sheet is provided near the second transfer device 22 and the fixing device 25.

Next, formation of a full-color image (color-copying) with the tandem developing device 120 will be explained. First, a document is set on a document table 130 of the automatic document feeder (ADF) 400, or the automatic document feeder 400 is opened, the document is set on a contact glass 32 of the scanner 300, and the automatic document feeder 400 is closed.

Upon a depression of a start switch (unillustrated), the scanner 300 is started after the document is conveyed onto the contact glass 32 when the document has been set on the automatic document feeder 400, or immediately after the depression of the start switch when the document has been set on the contact glass 32. Then, a first travelling member 33 and a second travelling member 34 are started to run. At this moment, the first travelling member 33 irradiates the document surface with light from a light source, and the second travelling member 34 reflects light reflected from the document surface with a mirror, so that the reflected light may be received by a reading sensor 36 through an imaging lens 35. In this way, the color document (color image) is read as image information of black, yellow, magenta, and cyan.

The image information for each of black, yellow, magenta, and cyan is transmitted to a corresponding one of the image forming units 18 (a black image forming unit, a yellow image forming unit, a magenta image forming unit, and a cyan image forming unit) of the tandem developing device 120. The image forming units form toner images of black, yellow, magenta, and cyan, respectively. The image forming units 18 (the black image forming unit, the yellow image forming unit, the magenta image forming unit, and the cyan image forming unit) of the tandem developing device 120 each include an electrostatic latent image bearing member (a black electrostatic latent image bearing member 10K, a yellow electrostatic latent image bearing member 10Y, a magenta electrostatic latent image bearing member 10M, and a cyan electrostatic latent image bearing member 10C), a charging device configured to electrically charge the electrostatic latent image bearing member uniformly, an exposing device configured to expose the electrostatic latent image bearing member to light imagewise like an image corresponding to the corresponding color image based on the corresponding color image information and form an electrostatic latent image corresponding to the color image on the electrostatic latent image bearing member, a developing device configured to develop the electrostatic latent image with a corresponding color toner (a black toner, a yellow toner, a magenta toner, and a cyan toner) to form a toner image based on the color toner, a transfer charging device configured to transfer the toner image onto the intermediate transfer member 50, a cleaning device, and a charge eliminating device. The image forming units 18 can form single-color images of the corresponding colors (a black image, a yellow image, a magenta image, and a cyan image) based on the image information of the corresponding colors. The black image, the yellow image, the magenta image, and the cyan image formed in this way on the black electrostatic latent image bearing member 10K, the yellow electrostatic latent image bearing member 10Y, the magenta electrostatic latent image bearing member 10M, and the cyan electrostatic latent image bearing member 10C are transferred (first-transferred) sequentially onto the intermediate transfer member 50 that is rotatively moved by the support rollers 14, 15, and 16. The black image, the yellow image, the magenta image, and the cyan image are overlaid together and a composite color image (a color transfer image) is formed on the intermediate transfer member 40.

Meanwhile, in the sheet feeding table 200, one of sheet feeding rollers 142 is selectively rotated to bring forward sheets (recording sheets) from one of sheet feeding cassettes 144 provided multi-stages in a paper bank 143. The sheets are sent out to a sheet feeding path 146 sheet by sheet separately via a separating roller 145, conveyed by a conveying roller 147 to be guided to a sheet feeding path 148 in the copier body 150, and stopped upon a hit on a registration roller 49. Alternatively, a sheet feeding roller 142 is rotated, and sheets (recording sheets) on a manual sheet feeding tray 54 are brought forward into a manual sheet feeding path 53 sheet by sheet separately via a separating roller 52 and likewise stopped upon a hit on the registration roller 49. The registration roller 49 is used in an earthed state commonly, but may be used in a bias-applied state for removal of paper dust from the sheets. Then, so as to be in time for the composite color image (color transfer image) combined on the intermediate transfer member 50, the registration roller 49 is started to rotate to send out the sheet (recording sheet) to between the intermediate transfer member 50 and the second transfer device 22, so that the composite color image (color transfer image) may be transferred (second-transferred) onto the sheet by the second transfer device 22. Through this, the color image is transferred and formed on the sheet (recording sheet). Any residual toner on the intermediate transfer member after having transferred the image is cleaned away by the intermediate transfer member cleaning device 17.

The sheet (recording sheet) on which the color image is transferred and formed is conveyed by the second transfer device 22 and delivered to the fixing device 25, and the composite color image (color transfer image) is fixed on the sheet (recording sheet) by the fixing device 25 with heat and pressure. After this, the sheet (recording sheet) is switched by a switching claw 55 to a discharging roller 56 to be discharged, and then stacked on a sheet discharging tray 57. Alternatively, the sheet is switched by the switching claw 55 to the sheet overturning device 28 to be overturned, guided again to the transfer position, and after having an image recorded also on the back side thereof, discharged by the discharging roller 56 and stacked on the sheet discharging tray 57.

### EXAMPLES

The present invention will be described in greater detail below based on Examples.

It is easy for a person ordinarily skilled in the art to make modifications and alterations to the Examples of the present invention described below and form another embodiment. Such modifications and alterations are included in the present invention, and the explanation to be given below is about the examples of a preferred embodiment of the present invention, and is not to limit the present invention.

Unless otherwise expressly specified, part represents part by mass, and % represents % by mass.

### (Synthesis of Binder Resin)

### —Synthesis of Binder Resin 1—

A 5-liter four-necked flask equipped with a nitrogen introducing pipe, a dehydrating pipe, a stirrer, and a thermocouple was charged with bisphenol A-propylene oxide adduct (0.6 mol) and bisphenol A-ethylene oxide adduct (0.6 mol) as alcohol components, terephthalic acid (0.8 mol) and adipic acid (0.2 mol) as carboxylic acid components, and tin octylate as an esterification catalyst, and they were allowed to undergo a condensation polymerization reaction under nitrogen atmosphere at 180° C. for 4 hours. After this, trimellitic acid (0.07 mol) was added thereto, and they were reacted at a raised temperature of 210° C. for 1 hour, and further reacted at 8 kPa for 1 hour, to thereby synthesize a polyester resin 1 (binder resin 1). The contact angle of this resin to water was 69°, the weight average molecular weight (Mw) thereof was 25,000, and the glass transition point (Tg) thereof was 58° C.

### —Synthesis of Binder Resin 2—

A 5-liter four-necked flask equipped with a nitrogen introducing pipe, a dehydrating pipe, a stirrer, and a thermocouple was charged with bisphenol A-propylene oxide adduct (0.5 mol) and bisphenol A-ethylene oxide adduct (0.5 mol) as alcohol components, terephthalic acid (0.7 mol) and adipic acid (0.3 mol) as carboxylic acid components, and tin octylate as an esterification catalyst, and they were allowed to undergo a condensation polymerization reaction under nitrogen atmosphere at 180° C. for 4 hours. After this, trimellitic acid (0.07 mol) was added thereto, and they were reacted at a raised temperature of 210° C. for 1 hour, and further reacted at 8 kPa for 1 hour, to thereby synthesize a polyester resin 2 (binder resin 2). The contact angle of this resin to water was 72°, the weight average molecular weight thereof was 70,000, and the glass transition point thereof was 61° C.

### —Synthesis of Binder Resin 3—

A four-necked flask equipped with a nitrogen introducing pipe, a dehydrating pipe, a stirrer, and a thermocouple was charged with bisphenol A-ethylene oxide 2 mol adduct and bisphenol A-propylene oxide 3 mol adduct at a molar ratio (bisphenol A-ethylene oxide 2 mol adduct/bisphenol A-propylene oxide 3 mol adduct) of 85/15, isophthalic acid and terephthalic acid at a molar ratio (isophthalic acid/terephthalic acid) of 80/20, at a molar ratio of hydroxyl group to carboxyl group OH/COOH of 1.4, and they were reacted with titanium tetraisopropoxide (500 ppm) at normal pressure at 230° C. for 8 hours, and further reacted at a reduced pressure of from 10 mmHg to 15 mmHg for 4 hours, to thereby obtain an intermediate polyester. Next, a reaction vessel was charged with trimellitic anhydride in an amount of 1 mol % relative to the whole resin components, and they were reacted at 180° C. at normal pressure for 3 hours, to thereby synthesize a binder resin 3. The contact angle of this resin to water was 77°, the weight average molecular weight thereof was 6,200, and the glass transition point thereof was 52° C.

### —Synthesis of Binder Resin 4—

A four-necked flask equipped with a nitrogen introducing pipe, a dehydrating pipe, a stirrer, and a thermocouple was charged with bisphenol A-ethylene oxide 2 mol adduct and bisphenol A-propylene oxide 3 mol adduct at a molar ratio (bisphenol A-ethylene oxide 2 mol adduct/bisphenol A-propylene oxide 3 mol adduct) of 85/15, isophthalic acid and terephthalic acid at a molar ratio (isophthalic acid/terephthalic acid) of 80/20, at a molar ratio of hydroxyl group to carboxyl group OH/COOH of 1.2, and they were reacted with titanium tetraisopropoxide (500 ppm) at normal pressure at 230° C. for 8 hours, and further reacted at a reduced pressure of from 10 mmHg to 15 mmHg for 4 hours. Next, a reaction vessel was charged with trimellitic anhydride in an amount of 1 mol % relative to the whole resin components, and they were reacted at 180° C. at normal pressure for 3 hours, to thereby obtain a non-crystalline polyester resin 4 (binder resin 4).

The contact angle of this resin to water was 79°, the weight average molecular weight thereof was 14,500, and the glass transition point thereof was 55° C.

### —Synthesis of Binder Resin 5—

A four-necked flask equipped with a nitrogen introducing pipe, a dehydrating pipe, a stirrer, and a thermocouple was charged with bisphenol A-ethylene oxide 2 mol adduct and bisphenol A-propylene oxide 3 mol adduct at a molar ratio (bisphenol A-ethylene oxide 2 mol adduct/bisphenol A-propylene oxide 3 mol adduct) of 85/15, isophthalic acid and terephthalic acid at a molar ratio (isophthalic acid/terephthalic acid) of 80/20, at a molar ratio of hydroxyl group to carboxyl group OH/COOH of 1.1, and they were reacted with titanium tetraisopropoxide (500 ppm) at normal pressure at 230° C. for 8 hours, and further reacted at a reduced pressure of from 10 mmHg to 15 mmHg for 4 hours. Next, a reaction vessel was charged with trimellitic anhydride in an amount of 1 mol % relative to the whole resin components, and they were reacted at 180° C. at normal pressure for 3 hours, to thereby obtain a non-crystalline polyester resin 5 (binder resin 5).

The contact angle of this resin to water was 82°, the weight average molecular weight thereof was 16,000, and the glass transition point thereof was 57° C.

### —Synthesis of Binder Resin 6—

A 5-liter four-necked flask equipped with a nitrogen introducing pipe, a dehydrating pipe, a stirrer, and a thermocouple was charged with bisphenol A-propylene oxide adduct (0.6 mol) and bisphenol A-ethylene oxide adduct (0.6 mol) as alcohol components, terephthalic acid (0.9 mol) as a carboxylic acid component, and tin octylate as an esterification catalyst, and they were allowed to undergo a condensation polymerization reaction under nitrogen atmosphere at 180° C. for 4 hours. After this, trimellitic anhydride (0.07 mol) was added thereto, and they were reacted at a raised temperature of 210° C. for 1 hour, and further reacted at 8 kPa for 1 hour, to thereby synthesize a polyester resin 6 (binder resin 6). The contact angle of this resin to water was 66°, the weight average molecular weight thereof was 14,000, and the glass transition point thereof was 53° C.

### —Binder Resin 7—

A styrene/n butyl acrylate copolymer resin was used. The contact angle of this styrene/n butyl acrylate copolymer resin to water was 84°, the weight average molecular weight thereof was 13,000, and the glass transition temperature thereof was 53° C.

The characteristics of the binder resins 1 to 7 are shown in Table 1.

TABLE 1

| | Binder resin | | | | | | |
|---|---|---|---|---|---|---|---|
| | 1 | 2 | 3 | 4 | 5 | 6 | 7 |
| Tg [° C.] | 58 | 61 | 52 | 55 | 57 | 53 | 53 |
| Mw | 25,000 | 70,000 | 6,200 | 14,500 | 16,000 | 14,000 | 13,000 |
| Contact | 69 | 72 | 77 | 79 | 82 | 66 | 84 |
| angle [°] | | | | | | | |

### (Preparation of Colorant Dispersion Liquid)

First, a dispersion liquid of carbon black as a colorant was prepared.

Carbon black (REGA L400 manufactured by Cabot Corporation) (17 parts) and a pigment dispersant (3 parts) were first-dispersed in ethyl acetate (80 parts) with a mixer including a stirring blade. AJISPER PB821 (manufactured by Ajinomoto Fine-Techno Co., Inc.) was used as the pigment dispersant. The obtained first dispersion liquid was dispersed finely with a strong shearing force with a beads mill (LMZ type manufactured by Ashizawa Finetech Ltd., with zirconia beads having a diameter of 0.3 mm), to thereby obtain a second dispersion liquid from which aggregates of 5 μm or greater were removed completely.

### (Preparation of Releasing Agent Dispersion Liquid)

Next, a releasing agent dispersion liquid was prepared.

A carnauba releasing agent (18 parts) and a releasing agent dispersant (2 parts) were first-dispersed in ethyl acetate (80 parts) with a mixer including a stirring blade. The obtained first dispersion liquid was warmed to 80° C. while being stirred, and after the carnauba releasing agent was dissolved, cooled to room temperature to thereby deposit releasing agent particles such that their maximum diameter may be 3 μm or less. As the releasing agent dispersant, a product obtained by grafting a styrene/butyl acrylate copolymer with a polyethylene releasing agent was used. The obtained dispersion liquid was further dispersed finely with a strong shearing force with a beads mill (LMZ type manufactured by Ashizawa Finetech Ltd., with zirconia beads having a diameter of 0.3 mm), and prepared such that the maximum diameter may be 1 μm or less.

### (Preparation of Toner Liquid)

Next, the respective dispersion liquids or dissolved liquids were stirred with a mixer including a stirring blade for 10 minutes and dispersed uniformly, such that the compositions of the binder resins, the colorant, and the releasing agent may be as shown in Table 2, to thereby obtain toner composition liquids. Aggregation of the pigment and releasing agent particles due to a shock of solvent dilution did not occur. Note that the solid content was adjusted with ethyl acetate.

TABLE 2

| | | | | | | Charge | Releasing | Releasing | Colorant | |
|---|---|---|---|---|---|---|---|---|---|---|
| | Binder resin (A) with | | Binder resin (B) with | | B's contact | controlling agent | agent | agent | (carbon | Solid |
| | large molecular weight | | small molecular weight | | angle − A's | (FCA2508N) | (carnauba) | dispersant | black) | content |
| | | (part by | | (part by | contact angle | (part by | (part by | (part by | (part by | (% by |
| | Kind of resin | mass) | Kind of resin | mass) | (°) | mass) | mass) | mass) | mass) | mass) |
| Toner composition | Binder resin | 80 | Binder resin | 20 | 8 | 1 | 10 | 0.5 | 5 | 10 |
| liquid A | 1 | | 3 | | | | | | | |
| Toner composition | Binder resin | 95 | Binder resin | 5 | 8 | 1 | 10 | 0.5 | 5 | 10 |
| liquid B | 1 | | 3 | | | | | | | |
| Toner composition | Binder resin | 80 | Binder resin | 20 | 10 | 1 | 10 | 0.5 | 5 | 10 |
| liquid C | 1 | | 4 | | | | | | | |
| Toner composition | Binder resin | 80 | Binder resin | 20 | 15 | 1 | 10 | 0.5 | 5 | 10 |
| liquid D | 1 | | 7 | | | | | | | |
| Toner composition | Binder resin | 80 | Binder resin | 20 | 5 | 1 | 10 | 0.5 | 5 | 10 |
| liquid E | 2 | | 3 | | | | | | | |
| Toner composition | Binder resin | 50 | Binder resin | 50 | 7 | 1 | 10 | 0.5 | 5 | 10 |
| liquid F | 2 | | 4 | | | | | | | |
| Toner composition | Binder resin | 80 | Binder resin | 20 | −3 | 1 | 10 | 0.5 | 5 | 10 |
| liquid G | 1 | | 6 | | | | | | | |
| Toner composition | Binder resin | 80 | Binder resin | 20 | 13 | 1 | 10 | 0.5 | 5 | 10 |
| liquid H | 1 | | 5 | | | | | | | |
| Toner composition | Binder resin | 100 | — | — | — | 1 | 10 | 0.5 | 5 | 10 |
| liquid I | 1 | | | | | | | | | |
| Toner composition | Binder resin | 100 | — | — | — | 1 | 10 | 0.5 | 5 | 10 |
| liquid J | 2 | | | | | | | | | |
| Toner composition | Binder resin | 80 | Binder resin | 20 | 8 | 1 | 10 | 0.5 | 5 | 50 |
| liquid K | 1 | | 3 | | | | | | | |

### Example A

### Production of Toner A

With the toner producing apparatus shown in FIG. 1, FIG. 2, and FIG. 3A, liquid droplets of the toner composition liquid A were discharged from a liquid droplet discharging head employing the liquid column resonance principle shown in FIG. 4A to FIG. 4D under the conditions described below. After this, the liquid droplets were dried, solidified, collected with a cyclone, and then secondly dried at 35° C. for 48 hours, to thereby produce toner base particles A.

### [Liquid Column Resonance Conditions]

Resonance mode: N=2

Length between longer-direction both ends of liquid column resonance liquid chamber: L=1.8 mm

Height of common liquid supply path side frame end of liquid column resonance liquid chamber: h1=80 μm

Height of communication port of liquid column resonance liquid chamber: h2=40 μm

### [Toner Base Particle Production Conditions]

Specific gravity of dispersion liquid: ρ=1.1 g/cm³

Shape of discharge holes: true circle

Diameter of discharge holes: 7.5 μm

Number of discharge hole openings: 4 per 1 liquid column resonance liquid chamber

Minimum interval between centers of adjoining discharge holes: 130 μm (all were at equal intervals)

Drying air temperature: 40° C.

Applied voltage: 10.0 V

Driving frequency: 395 kHz

### Example B

A toner B was obtained by using the toner composition B instead of the toner composition liquid A in Example A. Characteristics of the toner and clogging of the nozzles during jetting were evaluated, and the results are shown in Table 3.

### Example C

A toner C was obtained by using the toner composition liquid C instead of the toner composition liquid A in Example A. Characteristics of the toner and clogging of the nozzles during jetting were evaluated, and the results are shown in Table 3.

### Example D

A toner D was obtained by using the toner composition liquid D instead of the toner composition liquid A in Example A. Characteristics of the toner and clogging of the nozzles during jetting were evaluated, and the results are shown in Table 3.

### Example E

A toner E was obtained by using the toner composition liquid E instead of the toner composition liquid A in Example A. Characteristics of the toner and clogging of the nozzles during jetting were evaluated, and the results are shown in Table 3.

### Example F

A toner F was obtained by using the toner composition liquid F instead of the toner composition liquid A in Example A. Characteristics of the toner and clogging of the nozzles during jetting were evaluated, and the results are shown in Table 3.

### Comparative Example A

A toner G was obtained by using the toner composition liquid G instead of the toner composition liquid A in Example A. Characteristics of the toner and clogging of the nozzles during jetting were evaluated, and the results are shown in Table 3.

### Comparative Example B

A toner H was obtained by using the toner composition liquid H instead of the toner composition liquid A in Example A. Characteristics of the toner and clogging of the nozzles during jetting were evaluated, and the results are shown in Table 3.

### Comparative Example C

A toner I was obtained by using the toner composition liquid I instead of the toner composition liquid A in Example A. Characteristics of the toner and clogging of the nozzles during jetting were evaluated, and the results are shown in Table 3.

### Comparative Example D

A toner J was obtained by using the toner composition liquid J instead of the toner composition liquid A in Example A. Characteristics of the toner and clogging of the nozzles during jetting were evaluated, and the results are shown in Table 3.

### Comparative Example E

In Comparative Example E, the toner producing method was changed. Toner base particles K were produced according to the following procedure.

### —Synthesis of Styrene/Acrylic Resin Particles—

A reaction vessel equipped with a stirring bar and a thermometer was charged with water (683 parts), sodium salt of methacrylic acid-ethylene oxide adduct sulfate (ELEMINOL RS-30 manufactured by Sanyo Chemical Industries, Ltd.) (16 parts), styrene (83 parts), methacrylic acid (83 parts), butyl acrylate (110 parts), and ammonium persulfate (1 part), and they were stirred at 400 rpm for 15 minutes, which resulted in a white emulsion. The white emulsion was heated until the internal temperature in the system became 75° C., and reacted for 5 hours. A 1% by mass ammonium persulfate aqueous solution (30 parts) was added thereto, and they were aged at 75° C. for 5 hours, to thereby obtain an aqueous dispersion liquid of a vinyl-based resin (a copolymer of styrene/methacrylic acid/butyl acrylate/sodium salt of methacrylic acid-ethylene oxide adduct sulfate), i.e., [Styrene/Acrylic Resin Particle Dispersion Liquid A1]. The glass transition temperature Tg of the styrene/acrylic resin particles A1 was 62° C.

### —Synthesis of Acrylic Resin Particles—

A reaction vessel equipped with a stirring bar and a thermometer was charged with water (683 parts), distearyl dimethyl ammonium chloride (CATION DS manufactured by Kao Corporation) (10 parts), methyl methacrylate (144 parts), butyl acrylate (50 parts), ammonium persulfate (1 part), and ethylene glycol dimethacrylate (4 parts), and they were stirred at 400 rpm for 15 minutes, which resulted in a white emulsion. The white emulsion was heated until the internal temperature in the system became 65° C., and reacted for 10 hours. A 1% by mass ammonium persulfate aqueous solution (30 parts) was added thereto, and they were aged at 75° C. for 5 hours, to thereby obtain an aqueous dispersion liquid of a vinyl-based resin (methyl methacrylate), i.e., [Acrylic Resin Particle Dispersion Liquid B1]. The glass transition temperature Tg of the acrylic resin particles B1 was 79° C.

### ——Preparation of Aqueous Medium Phase——

Water (660 parts), the styrene/acrylic resin particle dispersion liquid A1 (25 parts), a 48.5% by mass aqueous solution of sodium dodecyldiphenyletherdisulfonate (“ELEMINOL MON-7” manufactured by Sanyo Chemical Industries, Ltd.) (25 parts), and ethyl acetate (60 parts) were mixed and stirred, to thereby obtain an opaque white liquid (aqueous phase). The acrylic resin particles B1 (50 parts) were added thereto, to thereby obtain [Aqueous Phase]. When it was observed with an optical microscope, aggregates of several hundred μm were confirmed. When this aqueous medium phase was stirred with a TK homomixer (manufactured by Tokushu Kika Kogyo Co., Ltd.) at a rotation speed of 8,000 rpm, the aggregates could be broken apart and dispersed into smaller aggregates of several which was confirmed with an optical microscope. Hence, it could be expected that the acrylic resin particles would disperse and attach to the liquid droplets of the toner material components in a toner material emulsifying step to be performed later. The acrylic resin particles would aggregate like this, but it would be important for them to be broken part under shearing, in order for them to attach to the surface of the toner uniformly.

### —Emulsification/Desolventization—

[Aqueous Phase] (1,200 parts) was added to a vessel charged with [Toner Composition Liquid K] (980 parts), and they were mixed with a TK homomixer at a rotation speed of 13,000 rpm for 20 minutes, to thereby obtain [Emulsified Slurry].

A vessel equipped with a stirrer and a thermometer was charged with [Emulsified Slurry], and it was desolventized at 30° C. for 8 hours, and after this, aged at 45° C. for 4 hours, to thereby obtain [Dispersed Slurry].

### —Washing/Drying—

[Dispersed Slurry] (100 parts) was filtered at reduced pressure. After this, the following operations (1) to (4) were performed twice, to thereby obtain [Filtration Cake 1].

(1) Ion-exchanged water (100 parts) was added to the filtration cake, and they were mixed with a TK homomixer (at a rotation speed of 12,000 rpm for 10 minutes), and after this, filtered.
(2) A 10% sodium hydroxide aqueous solution (100 parts) was added to the filtration cake of (1), and they were mixed with a TK homomixer (at a rotation speed of 12,000 rpm for 30 minutes), and after this, filtered at reduced pressure.
(3) 10% hydrochloric acid (100 parts) was added to the filtration cake of (2), and they were mixed with a TK homomixer (at a rotation speed of 12,000 rpm for 10 minutes), and after this, filtered.
(4) Ion-exchanged water (300 parts) was added to the filtration cake of (3), and they were mixed with a TK homomixer (at a rotation speed of 12,000 for 10 minutes), and after this, filtered.

[Filtration Cake 1] was dried with an air circulating drier at 45° C. for 48 hours and sieved through a mesh having a mesh size of 75 μm, to thereby obtain [Toner K].

### (Production of Carrier)

The composition described below was dispersed with a homomixer for 20 minutes, to prepare a coat layer forming liquid. With a fluid bed coater, the surface of spherical magnetite (1,000 parts) having a particle diameter of 40 μm was coated with this coat layer forming liquid, to thereby obtain a magnetic carrier.

### [Composition]

Silicone resin (organo straight silicone): 100 parts

Toluene: 100 parts

γ-(2-aminoethyl)aminopropyl trimethoxy silane: 5 parts

Carbon black: 10 parts

### (Production of Developer)

As for each of the toners A to L, a black toner (4 parts) and the magnetic carrier (96 parts) were mixed with a ball mill, to produce a two-component developer.

As for each of the two-component developers, particle size distribution, binding ratio, and fixability were evaluated according to the following methods.

### (Evaluation of Particle Size Distribution and Binding Ratio)

The particle size distribution and the binding ratio of the toner were measured with a flow-type particle image analyzer (FPIA-3000 manufactured by Sysmex Corporation) according to the measuring method described below.

### <<Measuring Method>>

A 10% by mass surfactant (alkylbenzene sulfonate, NEOGEN SC-A manufactured by Dai-Ichi Kogyo Seiyaku Co., Ltd.) (0.5 mL) was added to a glass-made 100 mL beaker, each toner (0.5 g) was added thereto and mixed therewith with a micro spatula, and then a particle sheath (manufactured by Sysmex Corporation) (80 mL) was added thereto. The obtained dispersion liquid was dispersed with an ultrasonic disperser (W-113MK-II manufactured by Honda Electronics Co., Ltd.) for 10 minutes.

With the flow-type particle image analyzer FPIA-3000, the dispersion liquid was measured for the first time for adjustment of the dispersion liquid concentration. The dispersion liquid was then measured for the second time by being diluted such that the effective analytical value to be indicated by the analyzer would be from 3,500 to 14,000. (The effective analytical value of the second measurement would approximately fall within the range of from 3,500 to 14,000, when the dispersion liquid is diluted with a particle sheath such a number of fold as is obtained by dividing the effective analytical value of the first measurement by 7,000. When the effective analytical value is 3,500 or less, the dispersion liquid would be re-prepared, by increasing the amount of the toner.) As the measuring conditions, the magnification of the objective lens was ×10, and the measuring mode was HPF. When the effective analytical value is less than 3,500, the number of particles measured is small, with a large margin of measuring error. When the effective analytical value is greater than 14,000, the sample concentration is high, and hence 2 particles have been analyzed as 1 particle. Therefore, the particle diameter may be larger or the circularity may be lower.

The particle size distribution was calculated using the obtained data. The volume average particle diameter (Dv) of the toner was an equivalent circle diameter (volumetric basis), and the number average particle diameter (Dn) of the toner was an equivalent circle diameter (number basis). The analytical conditions (for particle diameter and shape) were 0.500≦equivalent circle diameter<200.0, and 0.200≦circularity≦1.000.

The binding ratio was obtained as follows. The bound particle (including 2 particles) and the bound particle (including 3 particles) shown in FIG. 10E to FIG. 10G have a lower circularity than that of a fundamental particle. By varying the analytical condition (particle shape limitation: circularity) of the flow-type particle image analyzer FPIA-3000, the number of bound particles was counted, and the ratio of this number to the number of all particles was calculated.

The specific method was as follows. A limited number of particles counted on the analytical conditions (for particle diameter and shape) of 0.500≦equivalent circle diameter<200.0, and 0.200≦circularity≦1.000 was A. This number A was the number of all particles. A limited number of particles counted on the analytical conditions (for particle diameter and shape) of 0.500≦equivalent circle diameter<200.0, and 0.200≦circularity≦0.950 was B. The binding ratio was (B/A)×100[%].

### (Evaluation of Fixability)

With the tandem full-color image forming apparatus 100C shown in FIG. 9, a whole-surface solid image (with an image size of 3 cm×8 cm) was formed on transfer sheets (TYPE 6200 manufactured by Ricoh Company Ltd.) with a transferred toner deposition amount of 0.85±0.10 mg/cm², and fixed on the transfer sheets by varying the temperature of the fixing belt, and the presence or absence of a hot offset was visually evaluated. The difference between the highest temperature at which no hot offset occurred and the minimum fixing temperature was the fixable range [° C.]. The solid image was formed on the transfer sheet at a 3.0 cm position from the sheet passing direction leading end of the sheet. The speed at which the sheet was passed through the nip portion of the fixing device was 280 mm/s. A broader fixable range means a better hot offset resistance, and a range of about 50° C. is an average fixable range of conventional full-color toners.

### (Measurement of Contact Angle)

The contact angles CAa and CAb of a toner and the toner after hot-melted were measured according to the method described in the section of “Method for Measuring Contact Angle”. The results of evaluation of particle size distribution, contact angle, binding ratio, and fixability (fixable range) are shown in Table 3.

TABLE 3

| | | | | | | | Bind- | Fix- |
|---|---|---|---|---|---|---|---|---|
| | | | | | | | ing | able |
| | | Dv | Dv/ | CAa | CAb | CAa − | ratio | range |
| | Toner | [μm] | Dn | [°] | [°] | CAb | [%] | [° C.] |
| Ex. A | Toner A | 5.2 | 1.03 | 76 | 71 | 5 | 0.1 | 55 |
| Ex. B | Toner B | 5.0 | 1.04 | 76 | 69 | 7 | 0.4 | 60 |
| Ex. C | Toner C | 5.1 | 1.04 | 78 | 71 | 7 | 0.4 | 60 |
| Ex. D | Toner D | 5.1 | 1.02 | 82 | 72 | 10 | 0.1 | 60 |
| Ex. E | Toner E | 5.1 | 1.04 | 76 | 73 | 3 | 0.5 | 60 |
| Ex. F | Toner F | 5.2 | 1.03 | 79 | 76 | 3 | 0.2 | 55 |
| Comp. | Toner G | 4.9 | 1.13 | 69 | 68 | 1 | 10.2 | 60 |
| Ex. A | | | | | | | | |
| Comp. | Toner H | 5.1 | 1.12 | 81 | 72 | 9 | 8.5 | 60 |
| Ex. B | | | | | | | | |
| Comp. | Toner I | 5.0 | 1.13 | 69 | 69 | 0 | 10.9 | 65 |
| Ex. C | | | | | | | | |
| Comp. | Toner J | 5.2 | 1.13 | 72 | 72 | 0 | 8.3 | 65 |
| Ex. D | | | | | | | | |
| Comp. | Toner K | 5.0 | 1.13 | 68 | 71 | −3 | — | 55 |
| Ex. E | | | | | | | | |

The toners A to F of Examples A to F had a particle size distribution of 1.05 or less, a binding ratio of 0.5% or less, and a fixable range of 50° C. or more, and were excellent in all of the respects.

On the other hand, Comparative Examples A to D resulted in excellent fixable range, but poor binding ratio and particle size distribution. This is considered to be because the drying property of the resin deposited on the outermost surface of the particles was low, and the particles bound with each other while being dried, to thereby result in a poor particle size distribution. The toner of Comparative Example E was a toner produced by chemical granulation, and poorer than other toners in the particle size distribution. The value CAa-CAb of this toner was a negative value unlike the toners A to J. This is considered to be because a material having a small contact angle was unevenly deposited on the surface of the toner.

The present invention relates to a toner according to (1) below, but also includes the embodiments (2) to (10) below.

(1) A toner, including:

a binder resin,

wherein the toner is obtained by drying liquid droplets formed by discharging a toner composition liquid containing a hydrophobic medium from a discharge hole,

wherein the binder resin includes 2 or more kinds of binder resins having different contact angles (to water),

wherein the binder resin having a largest contact angle has a weight average molecular weight of 15,000 or less, and

wherein the other binder resins have a weight average molecular weight of greater than 15,000.

(2) The toner according to (1),

wherein a contact angle (CAa) of the toner before hot-melted and a contact angle (CAb) of the toner after hot-melted satisfy the following formula I:

CAb+3°≦CAa (Formula I).

(3) The toner according to (1) or (2),

wherein the binder resin having the largest contact angle has a glass transition point (TO of 50° C. or higher.

(4) The toner according to any one of (1) to (3),

wherein a ratio of the binder resin having the largest contact angle to the binder resins is from 5% by mass to 50% by mass.

(5) The toner according to any one of claims (1) to (4),

wherein a difference between the contact angle of the binder resin having the largest contact angle and the contact angles of the other binder resins is 5° or more

(6) The toner according to any one of (1) to (5),

wherein the toner has a volume average particle diameter of from 1 μm to 10 μm, and a particle size distribution, which is volume average particle diameter/number average particle diameter, of from 1.00 to 1.10.

(7) A tone producing method, including:

discharging a toner composition liquid from a discharge hole and forming liquid droplets; and

solidifying the liquid droplets;

wherein the toner composition liquid includes at least a binder resin and a releasing agent,

wherein the binder resin includes 2 or more kinds of binder resins having different contact angles (to water), and

wherein the binder resin having a largest contact angle has a weight average molecular weight of 15,000 or less.

(8) The toner producing method according to (7),

wherein the discharging a toner composition liquid is forming the liquid droplets by applying a vibration to the toner composition liquid in a liquid column resonance liquid chamber provided with at least one discharge hole to form a standing wave based on a liquid column resonance and discharge the toner composition liquid from the discharge hole formed in a region corresponding to an anti-node of the standing wave.

(9) The toner producing method according to (7) or (8),

wherein the discharging a toner composition liquid is forming the liquid droplets by applying with a vibration unit, a vibration to a thin film in which a plurality of discharge holes having a same opening size are formed, to discharge the toner composition liquid from the discharge holes.

(10) A developer, including at least:

the toner according to any one of (1) to (6); and

a carrier.

### REFERENCE SIGNS LIST

1 toner producing apparatus
2 liquid droplet discharging unit
11 liquid column resonance liquid droplet discharging unit
100C image forming apparatus
150 copier body
200 sheet feeding table
300 scanner
400 automatic document feeder

1. A toner, comprising:
a binder resin,
wherein the toner is obtained by granulating a toner composition in a hydrophobic medium, and then drying a granulated product,
wherein the binder resin comprises 2 or more kinds of binder resins having different contact angles to water,
wherein the binder resin having a largest contact angle has a weight average molecular weight of 15,000 or less, and
wherein the other binder resins have a weight average molecular weight of greater than 15,000.

2. The toner according to claim 1,
wherein a contact angle (CAa) of the toner before hot-melting and a contact angle (CAb) of the toner after hot-melting satisfy a formula (I):
CAb+3°≦CAa (Formula I).

3. The toner according to claim 1,
wherein the binder resin having the largest contact angle has a glass transition point (Tg) of 50° C. or higher.

4. The toner according to claim 1,
wherein a ratio of the binder resin having the largest contact angle to the binder resins is from 5% by mass to 50% by mass.

5. The toner according to claim 1,
wherein a difference between the contact angle of the binder resin having the largest contact angle and the contact angles of the other binder resins is 5° or more.

6. The toner according to claim 1,
wherein the toner has a volume average particle diameter of from 1 μm to 10 μm, and a particle size distribution, which is volume average particle diameter/number average particle diameter, of from 1.00 to 1.10.

7. A method of producing toner, comprising:
discharging a toner composition liquid from a discharge hole to form liquid droplets; and
solidifying the liquid droplets,
wherein the toner composition liquid comprises a binder resin and a releasing agent,
wherein the binder resin comprises 2 or more kinds of binder resins having different contact angles to water, and
wherein the binder resin having a largest contact angle has a weight average molecular weight of 15,000 or less.

8. The method according to claim 7,
wherein the discharging a toner composition liquid comprises forming the liquid droplets by applying a vibration to the toner composition liquid in a liquid column resonance liquid chamber that is provided with at least one discharge hole to form a standing wave based on a liquid column resonance and discharge the toner composition liquid from the discharge hole formed in a region corresponding to an anti-node of the standing wave.

9. The method according to claim 7,
wherein the discharging a toner composition liquid comprises forming the liquid droplets by applying with a vibration unit, a vibration to a thin film in which a plurality of discharge holes having a same opening size are formed, to discharge the toner composition liquid from the discharge holes.

10. A developer, comprising:
a toner; and
a carrier,
wherein the toner is obtained by granulating a toner composition in a hydrophobic medium, and then drying a granulated product,
wherein the binder resin comprises 2 or more kinds of binder resins having different contact angles to water,
wherein the binder resin having a largest contact angle has a weight average molecular weight of 15,000 or less, and
wherein the other binder resins have a weight average molecular weight of greater than 15,000.

11. The developer according to claim 10,
wherein a contact angle (CAa) of the toner before hot-melting and a contact angle (CAb) of the toner after hot-melting satisfy a formula (I):
CAb+3°≦CAa (Formula I).

12. The developer according to claim 10, wherein the binder resin having the largest contact angle has a glass transition point (Tg) of 50° C. or higher.

13. The developer according to claim 10, wherein a ratio of the binder resin having the largest contact angle to the binder resins is from 5% by mass to 50% by mass.

14. The developer according to claim 10, wherein a difference between the contact angle of the binder resin having the largest contact angle and the contact angles of the other binder resins is 5° or more.

15. The developer according to claim 10, wherein the toner has a volume average particle diameter of from 1 μm to 10 μm, and a particle size distribution, which is volume average particle diameter/number average particle diameter, of from 1.00 to 1.10.
